(19) United States
(12) Patent Application Publication
(10) Pub. No.: US 2026/0365146 A1
(43) Pub. Date: Nov. 19, 2026

(54) TERRAIN DETECTION AND METHODS OF USE THEREOF

(71) Applicant: Polaris Industries Inc., Medina, MN (US)

(72) Inventors: Jonathon Graus, Wyoming, MN (US); Alex Scheuerell, Wyoming, MN (US)

(73) Assignee: Polaris Industries Inc., Medina, MN (US)

(21) Appl. No.: 19/148,368

(22) PCT Filed: Jan. 19, 2024
(86) PCT No.: PCT/US2024/012271

§ 371 Date: Jul. 16, 2025

Related U.S. Application Data
(60) Provisional application No. 63/440,313, filed on Jan. 20, 2023.

(51) Int. Cl. B60T 8/176; B60T 8/17; B60T 8/171

(52) U.S. Cl. CPC B60T 8/176; B60T 8/1701; B60T 8/171; B60T 2210/14; B60T 2210/30; B60T 2260/02

(57) ABSTRACT

In embodiments of the present disclosure, a vehicle for traversing a terrain is provided. The vehicle comprises a plurality of ground engaging members and a frame supported by the plurality of ground engaging members. A plurality of sensors are supported by the plurality of ground engaging members and configured to monitor a plurality of vehicle characteristics. Further, at least one controller is operably coupled to the plurality of sensors, and a brake system is operably coupled to at least one of the plurality of ground engaging members. A steering assembly is operably coupled to at least one of the plurality of ground engaging members, and at least one controller is configured to determine if the terrain is a first terrain type or a second terrain type.

### CROSS-REFERENCE TO RELATED APPLICATIONS

The present disclosure claims priority to U.S. Provisional Application No. 63/440,313, filed Jan. 20, 2023, titled TERRAIN DETECTION AND METHODS OF USE THEREOF, attorney docket no. PLR-09-29613.01P-US, the complete disclosure of which is expressly incorporated herein by reference.

### FIELD OF THE DISCLOSURE

The present disclosure relates to all-terrain vehicles and, more particularly, to operating an all-terrain vehicle configured for off-road applications.

### BACKGROUND OF THE DISCLOSURE

Utility and recreational vehicles often traverse rough terrain but also frequent use cases on paved, or otherwise higher friction, surfaces. It may be advantageous for vehicles that transition between on-road and off-road applications to be able to distinguish between the various surfaces and alter one or more performance characteristics of the vehicle in the process.

### SUMMARY OF THE DISCLOSURE

In embodiments of the present disclosure, a vehicle for traversing a terrain is provided. The vehicle comprises a plurality of ground engaging members and a frame supported by the plurality of ground engaging members. A plurality of sensors are supported by the plurality of ground engaging members and configured to monitor a plurality of vehicle characteristics. Further, at least one controller is operably coupled to the plurality of sensors, and a brake system is operably coupled to at least one of the plurality of ground engaging members. A steering assembly is operably coupled to at least one of the plurality of ground engaging members, and at least one controller is configured to determine if the terrain is a first terrain type or a second terrain type. Additionally, based upon at least one of the plurality of vehicle characteristics, the controller is operable to operate the braking system with a first configuration if the terrain is the first terrain type and operate the braking system with a second configuration if the terrain is the second terrain type, the second terrain type being different than the first terrain type.

### BRIEF DESCRIPTION OF THE DRAWINGS

FIG. 1A illustrates a left front perspective view of an all-terrain vehicle of the present disclosure;

FIG. 1B illustrates a top view of another exemplary all-terrain vehicle for use with embodiments disclosed herein;

FIG. 2 illustrates a left rear perspective view of a braking assembly of the all-terrain vehicle of FIGS. 1A and 1B;

FIG. 3 illustrates a rear perspective view of the braking assembly of FIG. 2;

FIG. 4 illustrates a right front perspective view of a front portion of the braking assembly of FIG. 2;

FIG. 5 illustrates a junction member of the braking assembly of FIG. 2;

FIG. 6 illustrates a left rear perspective view of a front drive member of the all-terrain vehicle of FIGS. 1A and 1B;

FIG. 7 illustrates a left rear perspective view of a rear drive member of the all-terrain vehicle of FIGS. 1A and 1B

FIG. 8 illustrates a schematic view of an electronic braking circuit of an electrical system of the all-terrain vehicle of FIGS. 1A and 1B;

FIG. 9 illustrates a schematic view of a hydraulic circuit of the braking assembly of FIG. 2;

FIG. 10 illustrates a representative view of components of a vehicle of the present disclosure having an ESC system with a plurality of sensors, devices, and/or sub-systems integrated with a control unit of the vehicle;

FIG. 11 is a control diagram of a system of the present disclosure;

FIG. 12 is a schematic diagram of a steering assembly of the present disclosure;

FIG. 13A is an exemplary process sequence for terrain detection;

FIG. 13B is another process sequence for terrain detection;

FIG. 14A is a process sequence for a variety of brake configurations based on detected terrain;

FIG. 14B is a process sequence for a variety of operating characteristics based on detected terrain;

FIG. 15A is a frequency plot of a vehicle characteristic for an off-road terrain;

FIG. 15B is a frequency plot of a vehicle characteristic for an on-road terrain;

FIG. 16A is a process sequence for terrain detection;

FIG. 16B is another process sequence for terrain detection;

FIG. 17 is a subprocess sequence for terrain detection; and

FIG. 18 is a process for determining engagement of a brake assembly.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

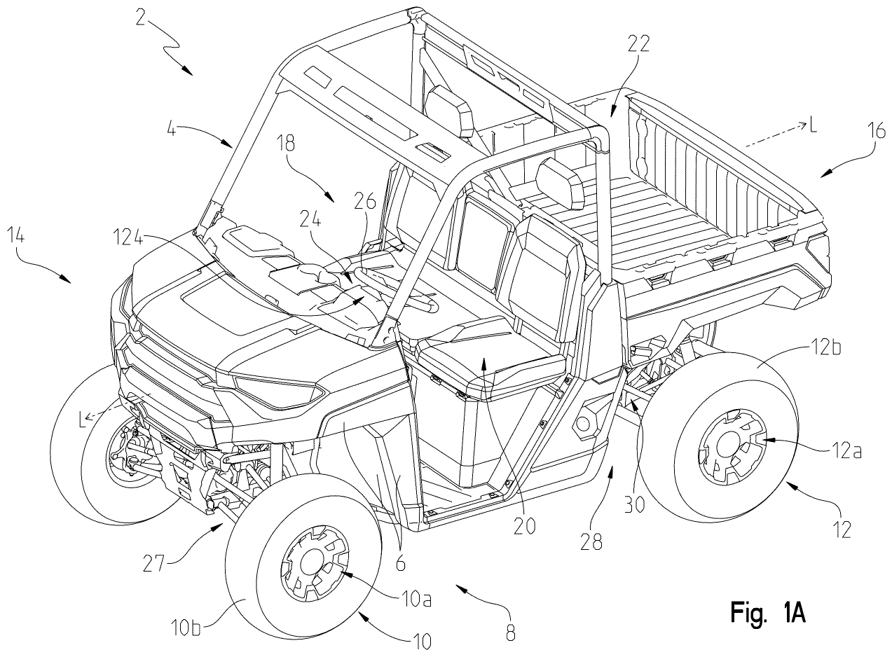

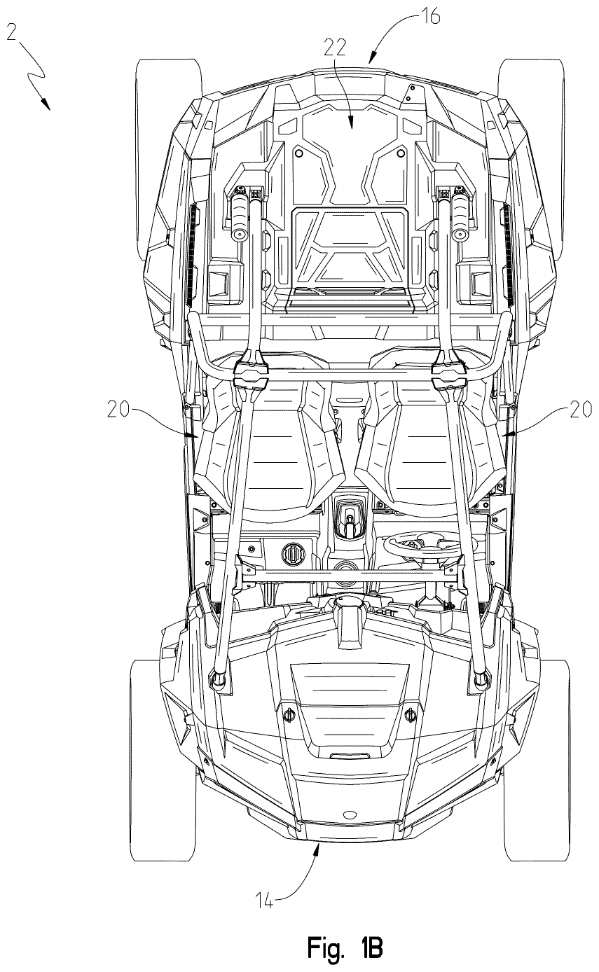

As shown in FIGS. 1A and 1B (collectively FIG. 1), an all-terrain vehicle 2 is disclosed and configured for off-road vehicle applications, such that all-terrain vehicle 2 is configured to traverse trails and other off-road terrain. Vehicle 2 may be referred to as a utility vehicle (“UTV”), an all-terrain vehicle (“ATV”), or a side-by-side vehicle (“SxS”) and is configured for travel over various terrains or surfaces. Exemplary terrains include on-road, such as asphalt or pavement or concrete and other non-loose materials, and off-road, such as trails, gravel, sand, dirt, grass, mud, and other off-road, non-pavement terrains. More particularly, vehicle 2 may be configured for military, industrial, agricultural, or recreational applications.

Additional details regarding vehicle 2 are provided in U.S. patent application Ser. No. 14/051,700, filed Oct. 11, 2013, titled SIDE-BY-SIDE VEHICLE, docket PLR-15-25448.04P-US-e, the entire disclosure of which is expressly incorporated by reference herein. Additionally, the systems and methodologies described herein are applicable and, in embodiments, may be incorporated into various other all-terrain vehicles including the side-by-side all-terrain vehicle disclosed in U.S. patent application Ser. No. 14/051,700, filed Oct. 11, 2013, titled SIDE-BY-SIDE VEHICLE, docket PLR-15-25448.04P-US-e, the entire disclosure of which is expressly incorporated by reference herein. Further, the systems and methodologies described herein are applicable and, in embodiments, may be incorporated into the included and the side-by-side all-terrain vehicle disclosed in U.S. patent application Ser. No. 15/790,691, filed Oct. 23, 2017, titled SIDE-BY-SIDE VEHICLE, docket PLR-15-24357.02P-04-US-e, the entire disclosure of which is expressly incorporated by reference herein.

Referring to FIG. 1, all-terrain vehicle 2 includes a frame assembly 4 which supports a plurality of body panels 6 and is supported on a ground surface by a plurality of ground-engaging members 8. Illustratively, ground-engaging members 8 include front ground-engaging members 10 and rear ground-engaging members 12. In one embodiment of vehicle 2, each of front ground-engaging members 10 may include a wheel assembly 10a and a tire 10b supported thereon. Similarly, each of rear ground-engaging members 12 may include a wheel assembly 12a and a tire 12b supported thereon. A front suspension assembly 27 may be operably coupled to front ground-engaging members 10 and a rear suspension assembly 28 may be operably coupled to rear ground-engaging members 12.

Referring still to FIG. 1, all-terrain vehicle 2 extends between a front-end portion 14 and a rear end portion 16 along a longitudinal axis L and supports an operator area 18 there between. Operator area 18 includes seating 20 for at least the operator and also may support one or more passengers. In one embodiment, seating 20 includes side-by-side bucket-type seats while, in another embodiment, seating 20 includes a bench-type seat. A cargo area 22 is positioned rearward of operator area 18 and is supported by frame assembly 4 at rear end portion 16.

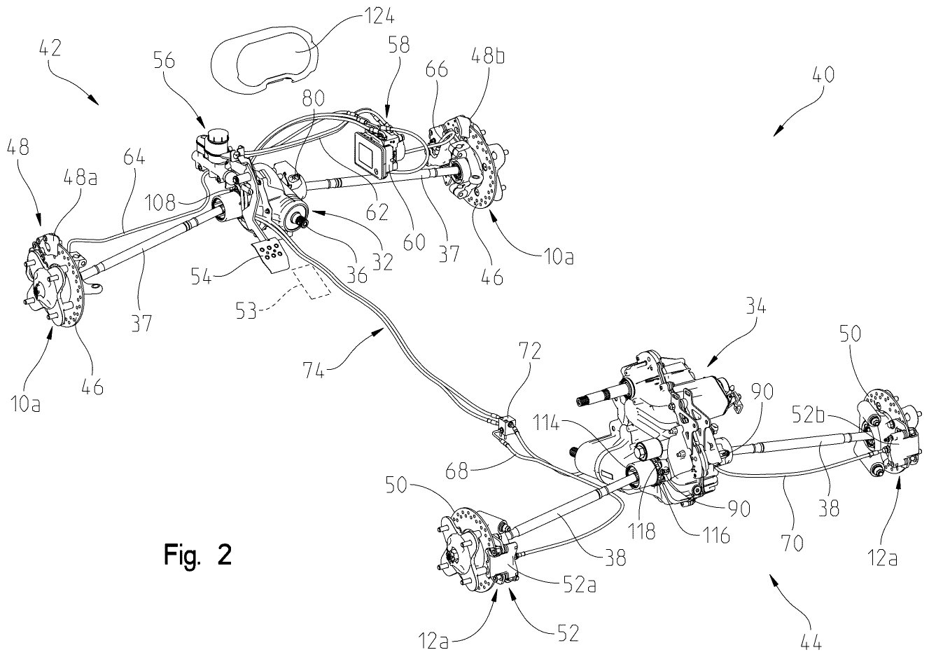

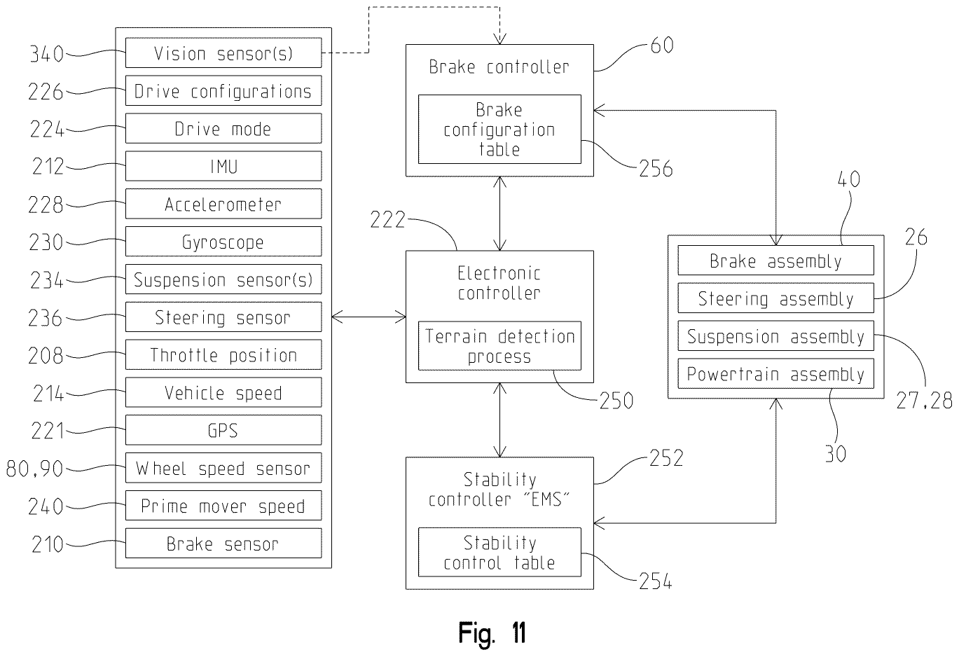

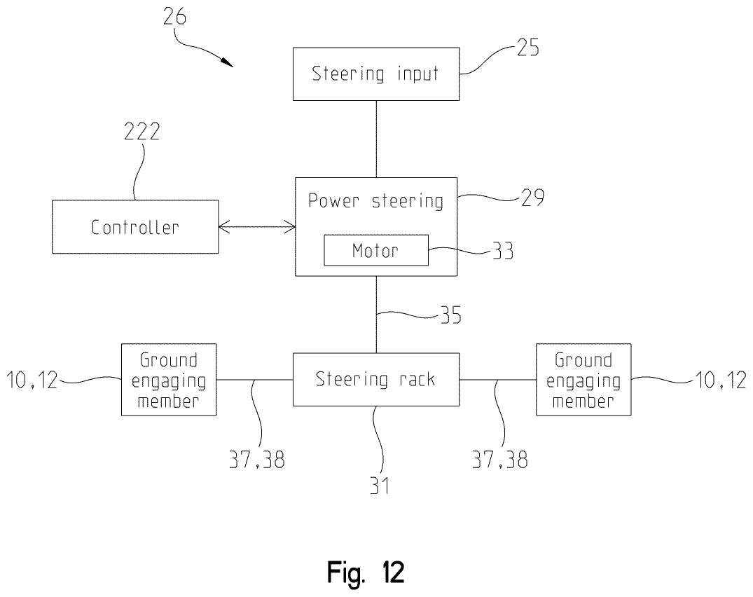

As shown in FIG. 1, operator area 18 includes operator controls 24, such as steering assembly 26, which may be operably coupled to one or more of ground-engaging members 8. Steering assembly 26 may include a power steering unit 29 (FIG. 12) operably coupled between a steering input 25 and at least one of the front ground engaging members 10. In embodiments, a steering rack 31 (FIG. 12) is positioned intermediate power steering unit 29 and at least one of front ground engaging members 10. Additional operator controls 24 may include other inputs for controlling operation of vehicle 2, as disclosed further herein, such as an accelerator member or pedal 53 and a brake member or pedal 54 (FIG. 2). More particularly, various operator controls 24 may affect operation of a powertrain assembly 30 of vehicle 2. Powertrain assembly 30 may be supported by rear end portion 16 of vehicle 2 and includes an engine (not shown), a transmission (e.g., transmission 217 illustrated in FIG. 11) operably coupled to the engine, a front final drive member 32 (FIG. 2) operably coupled to front ground-engaging members 10 through front half shafts or axles 37, and a rear final drive member 34 (FIG. 2) operably coupled to rear ground-engaging members 12 through rear half shafts or axles 38. Additionally, the transmission of powertrain assembly 30 may include a continuously variable transmission (“CVT”) alone, a shiftable transmission alone, or a combination of a CVT and shiftable transmission. Exemplary powertrain assemblies are disclosed in U.S. patent application Ser. No. 14/051,700, filed Oct. 11, 2013, titled SIDE-BY-SIDE VEHICLE, docket PLR-15-25448.04P-US-e and U.S. patent application Ser. No. 15/790,691, filed Oct. 23, 2017, titled SIDE-BY-SIDE VEHICLE, docket PLR-15-24357.02P-04-US-e, the entire disclosures of which are expressly incorporated by reference herein. A drive shaft (not shown) may be operably coupled to front final drive member 32 at an input 36 (FIG. 2) for supplying motive power from the engine and/or transmission to front ground-engaging members 10. Rear final drive member 34 is operably coupled the engine and/or transmission to supply power therefrom to rear ground-engaging members 12. In embodiments, powertrain assembly 30 includes one or more electric motors, a hybrid powertrain (e.g., combination of internal combustion engine and electric motor) or another type of prime mover configured to provide motive force to at least one of front ground engaging members 10 or rear ground engaging members 12.

FIG. 1 illustrates one embodiment of an exemplary off-road vehicle. However, in some embodiments, the all-terrain vehicle 2 may be extended along the longitudinal axis L and/or retracted along the longitudinal axis L, allowing the all-terrain vehicle 2 to be larger and/or smaller than the exemplary off-road vehicle 2 shown in FIG. 1. For instance, the all-terrain vehicle 2 may include two or more rows of seating 20, which may extend the all-terrain vehicle 2 along the longitudinal axis L. Additionally, or alternatively, in some embodiments, the cargo area 22 may be larger—allowing a user to store more cargo in the all-terrain vehicle 2. Additionally, or alternatively, in some embodiments, the all-terrain vehicle 2 may be wider than the embodiment shown in FIG. 1. For example, the seating 20 might not be side-by-side bucket-type seats. Instead, the seating 20 may include three or more seats that are side-by-side. The present disclosure encompasses the exemplary embodiment shown in FIG. 1, along with all other exemplary embodiments of off-road vehicles, such as the example shown in FIG. 1A.

Referring to FIGS. 2-4, vehicle 2 includes a braking assembly 40, illustratively an electronic stability control system (“ESC”) which includes a front-end braking portion 42 positioned generally at front end portion 14 of vehicle 2 and is operably coupled to front ground-engaging members 10 and a rear-end braking portion 44 positioned generally at rear end portion 16 of vehicle 2 and is operably coupled to rear ground-engaging members 12. Front end braking portion 42 includes front brake discs 46 and front brake calipers 48 operably coupled to front wheel assemblies 10a. Rear end braking portion 44 includes rear brake discs 50 and rear brake calipers 52 operably coupled to rear wheel assemblies 12a.

As shown in FIGS. 2-4, braking assembly 40 also includes brake member 54, illustratively a brake pedal, positioned within operator area 18 and is defined as one of the operator controls 24 (FIG. 1). Brake member 54 is operably coupled to a brake master cylinder 56 such that braking input from the operator of vehicle 2 is applied to brake member 54 and is transmitted to brake master cylinder 56.

Referring still to FIGS. 2-4, brake master cylinder 56 is operably coupled to a braking control system 58 which includes a brake controller, or hydraulic and electric controller unit (HECU) 60. More particularly, brake master cylinder 56 is fluidly coupled to HECU 60 through conduit(s) or line(s) 62. Illustratively, HECU 60 may be hydraulically actuated such that pressurized hydraulic fluid is configured to assist with the operation of braking assembly 40.

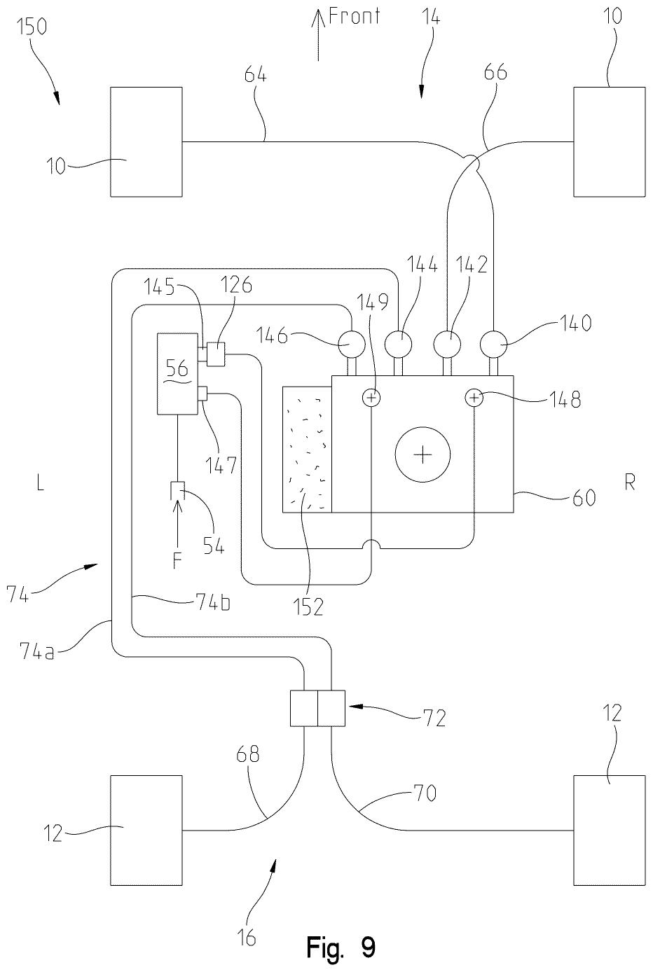

HECU 60 also is fluidly coupled with brake calipers 48, 52. Illustratively, as shown in FIGS. 2-4, braking assembly 40 further includes a front left conduit or line 64, a front right conduit or line 66, a rear left conduit or line 68, and a rear right conduit or line 70 which are all fluidly coupled to HECU 60 through four channels, namely a front left channel 140, a front right channel 142, a rear left channel 144, and a rear right channel 146, respectively (FIG. 9). In this way, front left conduit 64 fluidly couples front left brake caliper 48a with HECU 60, front right conduit 66 fluidly couples front right brake caliper 48b with HECU 60, rear left conduit 68 fluidly couples rear left brake caliper 52a with HECU 60, and rear right conduit 70 fluidly couples rear right brake caliper 52b with HECU 60. HECU 60 also may include an input 148 fluidly coupled to a front master cylinder output 145 and an input 149 fluidly coupled to a rear master cylinder output 147.

Referring to FIGS. 2-5, with respect to rear end braking portion 44, conduits 68, 70 are fluidly coupled to HECU 60 through a junction member or box 72. Illustratively, at least one junction conduit or line 74 (illustratively first and second junction conduits 74a, 74b) extends from HECU 60 to junction member 72 such that HECU 60 is fluidly coupled with rear brake calipers 52a, 52b through junction conduit 74, junction member 72, and respective rear left and right conduits 68, 70.

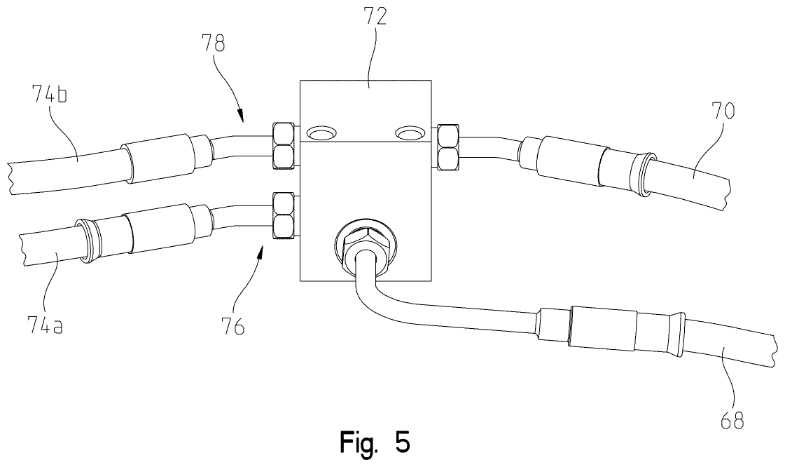

As shown best in FIG. 5, junction member 72 includes a first input 76 fluidly coupled to rear left conduit 68 through first junction conduit 74a and a second input 78 fluidly coupled to rear right conduit 70 through second junction conduit 74b. Junction member 72 facilitates serviceability of braking assembly 40 because if a repair or replacement is needed to rear end braking portion 44, then the repair or replacement may be made at the location of junction member 72, rather than having to fully disassemble all of braking assembly 40 for a repair to only a portion thereof. Additionally, junction member 72 is provided to allow for different braking pressures to be transmitted to rear brake calipers 52a, 52b. For example, a first braking pressure may be provided to rear brake caliper 52a through first junction conduit 74a and rear left conduit 68 while a greater or lesser braking pressure may be provided rear brake caliper 52b through second junction conduit 74b and rear right conduit 70.

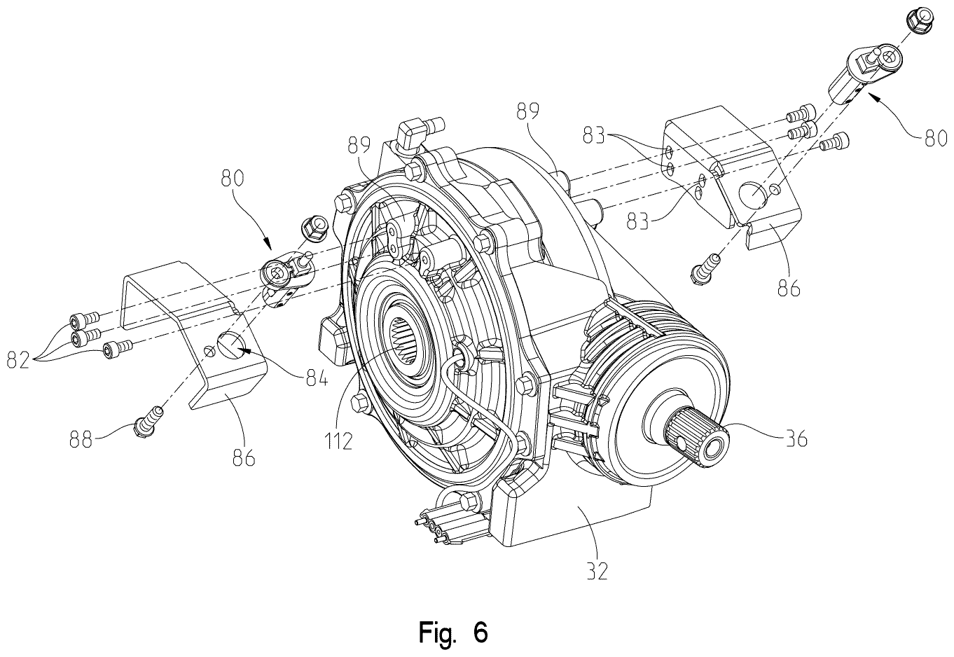

Referring now to FIG. 6, braking control system 58 further includes front wheel speed sensors 80 configured to determine the rotational speed of front ground-engaging members 10 (FIG. 1). Illustratively, each of front ground-engaging members 10 includes an individual wheel speed sensor 80. In one embodiment, wheel speed sensor 80 is coupled to a portion of front final drive member 32 through fasteners 82. Additionally, or alternatively, according to certain embodiments, the wheel speed sensor(s) 80 is housed in a knuckle of a ground-engaging member 10, 12 and the encoder is on the CV bell or integrated into a bearing of the ground-engaging member 10, 12. As shown in FIG. 6, wheel speed sensor 80 is received through an aperture 84 of a mounting bracket 86. Mounting bracket 86 is coupled to a lateral portion of front final drive member 32 with fasteners 82 which are received within mounting bores 89 on the lateral portions of front final drive member 32. More particularly, fasteners 82 are received within openings 83 on bracket 86, which have an oval or oblong shape, thereby allowing the position of bracket 86 and sensor 80 to be adjustable relative to axle 37. Additional fasteners or couplers 88 are configured to removably couple sensor 80 on mounting bracket 86. It may be appreciated that sensor 80 is generally surrounded by mounting bracket 86 such that mounting bracket 86 conceals at least a portion of sensor 80 from debris and/or objects that may travel towards sensor 80 when vehicle 2 is moving, thereby minimizing damage to sensor 80 during operation of vehicle 2.

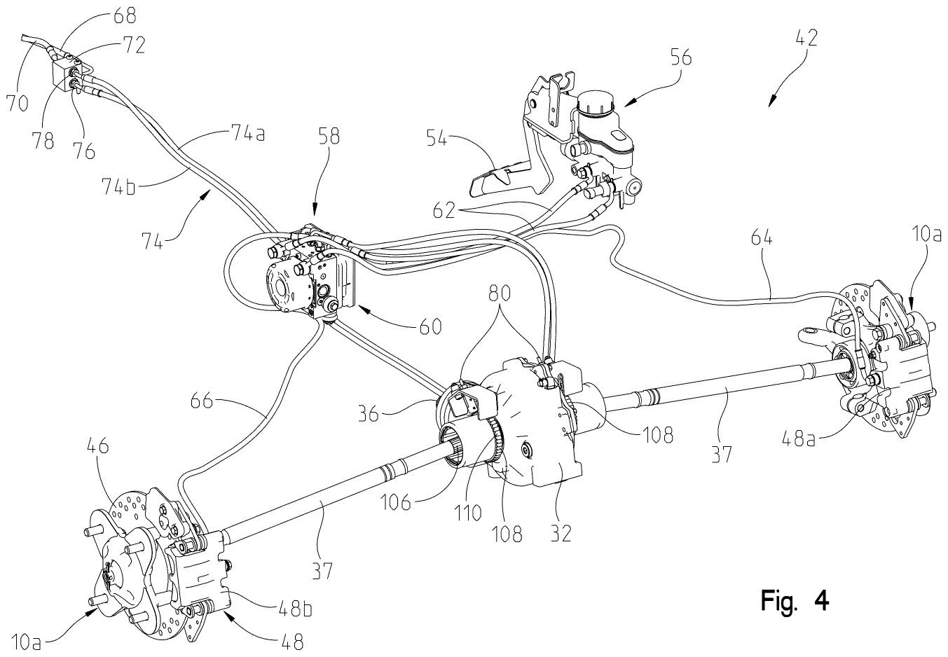

As shown best in FIG. 4, each of front half shafts 37 includes a drive coupling with a splined shaft 106. Splined shaft 106 may couple with an output 112 (FIG. 6) of front final drive member 32. Additionally, a gear ring 108 is positioned on the outer surface of each of the drive couplings and is held in position relative to half shafts 37. As such, gear ring 108 is configured to rotate with its corresponding half shaft 37. Each of gear rings 108 includes a plurality of teeth 110 which cooperate with sensor 80 to determine the speed of each half shaft 37. Sensors 80 are positioned in proximity to teeth 110 but do not contact teeth 110; rather sensors 80 count teeth 110 as teeth 110 pass sensor 80 over a specific time period to calculate an angular velocity. Sensors 80 may be speed sensors such as Hall Effect speed sensors.

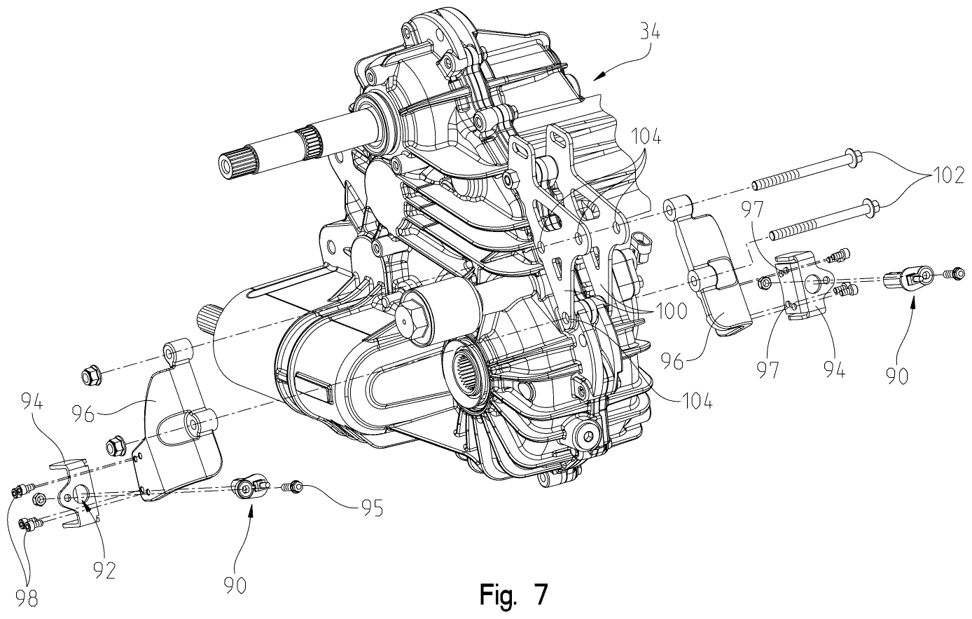

Referring to FIG. 7, braking control system 58 also includes rear wheel speed sensors 90 configured to determine the rotational speed of rear ground-engaging members 12 (FIG. 1). Illustratively, each of rear ground-engaging members 12 includes an individual wheel speed sensor 90. In one embodiment, wheel speed sensor 90 is coupled to a portion of rear final drive member 34. As shown in FIG. 7, wheel speed sensor 90 is received through an aperture 92 of a first mounting bracket 94 and is coupled to first mounting bracket 94 with fasteners 95. It may be appreciated that sensor 90 is generally surrounded by first mounting bracket 94 such that mounting bracket 94 conceals at least a portion of sensor 90 from debris and/or objects that may travel towards sensor 90 when vehicle 2 is moving, thereby minimizing damage to sensor 90 during operation of vehicle 2.

First mounting bracket 94 is coupled to a second mounting bracket 96 through fasteners 98. More particularly, fasteners 98 are received within openings 97 on first mounting bracket 94, which have an oval or oblong shape, thereby allowing the position of first mounting bracket 94 and sensor 90 to be adjustable relative to axle 38. Further, second mounting bracket 96 is coupled to retainer members 100 on lateral portions of rear final drive member 34. Additional fasteners or couplers 102 are configured to removably couple second mounting bracket 96 to retainers 100 because fasteners 102 are received through apertures 104 of retainers 100. It may be appreciated that retainers 100 include a plurality of apertures 104 such that fasteners 102 can be received through any of apertures 104 to adjust the position of second mounting bracket 96 relative to axle 38, thereby also allowing for the position of sensor 90 to be adjustable relative to axle 38.

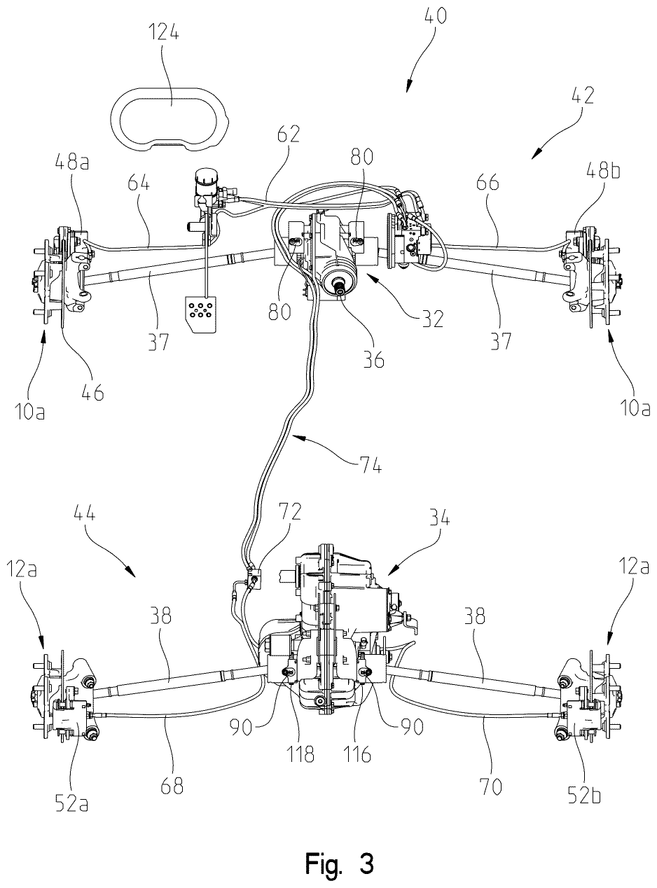

As shown best in FIGS. 2 and 3, each of rear half shafts 38 includes a drive coupling with a splined shaft 114 (FIG. 3). Splined shaft 114 couples with an output (not shown) of rear final drive member 34. Additionally, a gear ring 116 is positioned on the outer surface of each of the rear drive couplings and is held in position relative to its corresponding rear half shaft 38. As such, gear ring 116 is configured to rotate with its corresponding rear half shaft 38. Each of gear rings 116 includes a plurality of teeth 118 which cooperate with sensor 90 to determine the speed of each rear half shaft 38. Sensors 90 are positioned in proximity to teeth 118 but do not contact teeth 118; rather sensors 90 count teeth 118 as teeth 118 pass sensor 90 over a specific time period to calculate an angular velocity. Sensors 90 may be speed sensors such as Hall Effect speed sensors.

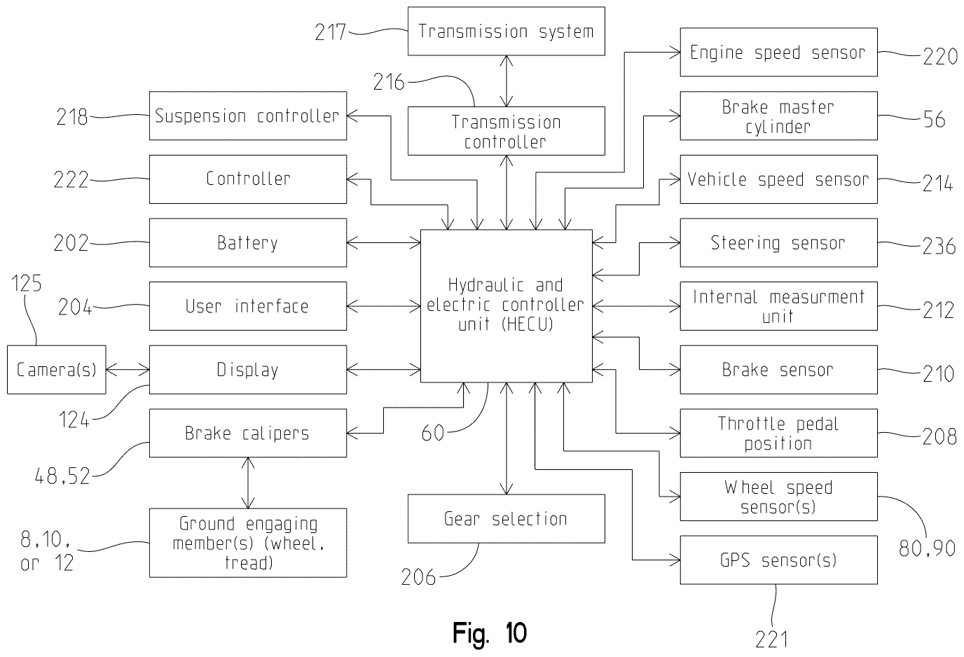

Referring to FIG. 10, the HECU 60 is electronically coupled or integrated with an electronic controller 222 of vehicle 2. In some embodiments, the HECU 60 and/or controller 222 may provide electronic control of the various components of vehicle 2. In embodiments, HECU 60 and controller 222 are a unitary controller. Further, the HECU 60 and controller 222 are operatively coupled to a plurality of vehicle sensors and/or devices that monitor various parameters of vehicle 2 or the environment surrounding vehicle 2. The HECU 60 and/or controller 222 performs certain operations to control one or more subsystems of other vehicle components, such as the operation of the braking assembly 40. For example, referring back to FIG. 2, the HECU 60 may be configured to hydraulically actuate the ESC system to assist with the operation of the braking assembly 40 (e.g., transfer and/or displace hydraulic fluid to one or more brake calipers, such as brake calipers 48a, 48b, 52a, and/or 52b, to cause the one or more ground-engaging members 10 or 12 to brake). In various embodiments, controller 222 is configured to provide a plurality of instructions to HECU 60 and HECU 60 is configured to execute the instructions provided by controller 222. The HECU 60 may be configured to control any type of braking system that permits the vehicle 2 to control the brake pressure on one or more ground-engaging members 10 or 12 as needed without a driver depressing/actuating a brake member, such as brake pedal 54. In other words, the HECU 60 may be configured to perform any of the processing sequences below for any type of braking system that permits the vehicle 2 to control (e.g., apply and/or remove) brake pressure to the ground-engaging members 10 and/or 12 independent of the driver input indicating a braking event (e.g., applying brake pressure without needing a driver to depress the brake pedal 54). The HECU 60 may determine the braking event based on actuation of the brake member 54 (e.g., a brake pedal). In some instances, the HECU 60 may be configured to operate in an HECU intervention mode (e.g., an anti-lock braking system (ABS) mode and/or an electronic stability control (ESC) mode). In embodiments, controller 222 is configured to provide instructions to HECU 60 to operate in any and all intervention modes. For example, in some variations, when operating in the ESC mode, the HECU, or brake controller 60 may be configured to reduce brake pressure to one or more of the ground-engaging members 10, 12. In other variations, when operating in the ESC mode, the HECU 60 may be configured to control (e.g., reduce, maintain, and/or increase) brake pressure to one or more of the ground-engaging members 10, 12.

According to certain embodiments, the HECU 60 may operate in an active descent mode, which may be enabled by a user and/or automatically activated by the HECU 60. In an active descent mode, the vehicle speed sensor 214 and/or the wheel speed sensors 80, 90 may measure an increase in speed without a corresponding input from the throttle pedal position 208 sensor. Based on the increase in speed without an input from the throttle pedal position 208 sensor, the HECU 60 may determine the vehicle 2 is on an incline and/or unintentionally speeding up. As such, the HECU 60 may apply brake pressure to one or more of the ground-engaging members 10, 12 in order to slow the vehicle 2 when the vehicle 2 speed is increasing without an input from the throttle pedal.

In some embodiments, the HECU 60 forms a portion of a processing subsystem including one or more computing devices having memory, processing, and communication hardware (e.g., HECU 60 may operate with controller 222 or other controllers 218, 216). The HECU 60 may be a single device (e.g., controller) or a distributed device, and the functions of the HECU 60 may be performed by hardware and/or as computer instructions on a non-transitory computer readable storage medium.

Electrical system 120 of vehicle 2 may include an engine control module (“ECM”), or a controller 222 and at least one display, gauge, and/or user interface 124. Display 124 is supported within operator area 18 (FIG. 1) and is configured to provide information about vehicle 2 to the operator. In one embodiment, HECU 60 may communicate with the display 124 such that the operator may provide a user input or user selection through display 124. Illustrative display 124 may include toggle switches, buttons, a touchscreen, or any other type of surface or member configured to receive and transmit a selection made by the user. For instance, the user may activate and/or toggle a button on the display 124. The display 124 may transmit a signal to the HECU 60 indicating the button has been actuated. Based on the particular button, the HECU 60 may generate one or more commands for the braking assembly 40 (e.g., displacing hydraulic fluid to one or more brake calipers 48a, 48b, 52a, and/or 52b) based on the actuation of the user input and/or on the actuation of the user input and one or more monitored parameters, such as sensor values.

Additionally, or alternatively, HECU 60 and controller 222 is configured to transmit information about braking assembly 40 to display 124 to provide such information to the operator. For example, the HECU 60 may be configured to transmit a fault signal to display 124 to indicate to the operator that a fault has occurred within a portion of braking assembly 40, such as a fault of the ESC feature of braking assembly 40. The fault indicator provided on display 124 may be a light, an alphanumeric code or message, or any other indication configured to alert the user of the fault.

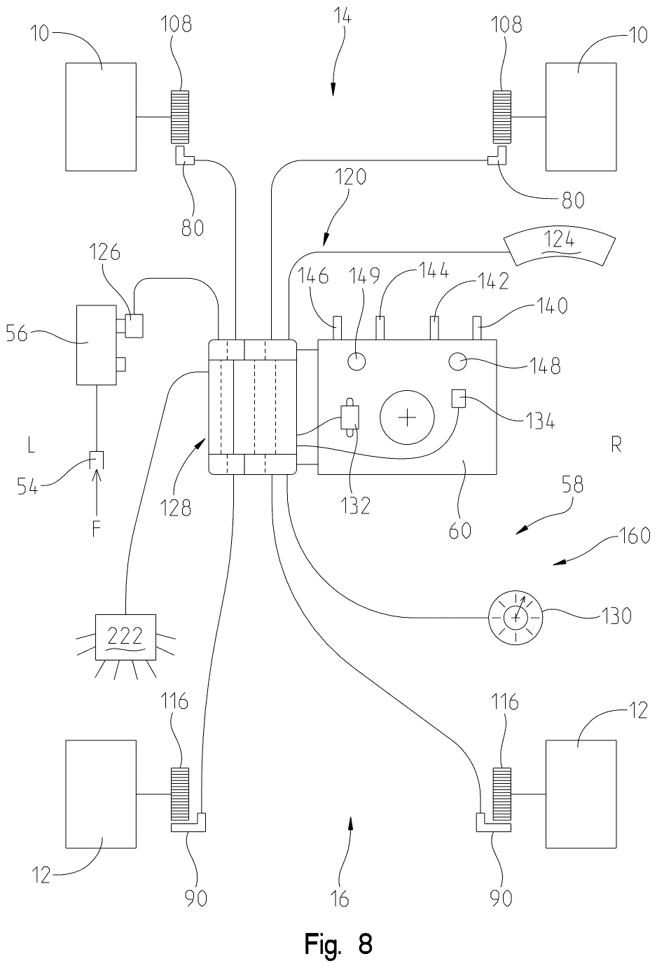

Additionally, or alternatively, controller 222 is in electronic communication with the display 124 and/or the HECU 60 to provide information to the operator and/or controller about the engine (not shown) or other components of powertrain assembly 30 or either of the suspensions 27, 28, or steering assembly 26. Illustratively, controller 222 transmits various signals to provide information such as an engine speed (RPM) 240, engine torque, engine temperature, oil pressure, the driving gear or mode, and/or any other information about powertrain assembly 30. Additionally, as shown in FIG. 8, display 124 is configured to provide inputs and other information to controller 222. For example, if illustrative vehicle 2 is configured with an adjustable speed limiting device and feature, the user may input speed limits to display 124 which are transmitted to controller 222 from display 124 to control the speed of vehicle 2, as disclosed further herein.

Referring to FIG. 8, a schematic view of braking control system 58 and at least a portion of electrical system 120 is disclosed with respect to operation of braking assembly 40. As denoted, front end portion 14 and rear end portion 16 are shown and the left side of vehicle 2 is denoted with “L” and the right side of vehicle 2 is denoted with “R.” As shown in FIG. 8, when the operator depresses brake member 54 with a force F, force F is transmitted to brake master cylinder 56, which may be a tandem master cylinder in one embodiment. Brake master cylinder 56 is configured to transmit braking input information to a brake pressure switch 126. Brake pressure switch 126 is then configured to transmit a signal indicative of braking pressure information to a multi-pin connector 128. Multi-pin connector 128 also may be configured to transmit and/or receive information to and from controller 222, a steering sensor 236, the display 124, and/or the HECU 60. In embodiments, brake master cylinder 56 is operably coupled to one or more of a brake pressure switch and a brake pressure sensor (not shown).

HECU 60 may include a multi-axis G sensor 132 and a pressure sensor 134, one or both of which may be internal or external sensors and are configured for communication with multi-pin connector 128. Additionally, multi-pin connector 128 is electrically coupled with front wheel speed sensors 80 and rear wheel speed sensors 90.

Referring now to FIG. 9, a schematic view of a hydraulic system 150 of vehicle 2 is disclosed with respect to operation of braking assembly 40. Hydraulic system 150 includes a hydraulic reservoir 152 fluidly coupled to HECU 60 and also fluidly coupled to junction member 72, and ground-engaging members 10, 12 through any of conduits 64, 66, 68, 70, 74. In operation, as force F is applied to brake member 54 by the operator, brake master cylinder 56 transmits force F to HECU 60 through at least brake pressure switch 126. More particularly, brake master cylinder 56 is in communication with HECU 60 between front and rear master cylinder outputs 145, 147 and inputs 148, 149, respectively which allows hydraulic fluid from hydraulic fluid reservoir 152 to flow to front and rear ground-engaging members 10, 12 through channels 140, 142, 144, 146.

Illustratively, and still referring to FIG. 9, as force F is applied to brake member 54, brake master cylinder 56 provides an input to front master cylinder output 145 through brake pressure switch 126 to initiate a flow of hydraulic fluid to input 148 through front left channel 140 and front left conduit 64 to front left ground-engaging member 10. Additionally, the input provided to front master cylinder output 145 through brake pressure switch 126 also initiates a flow of hydraulic fluid to input 148 through front right channel 142 and front right conduit 66 to front right ground-engaging member 10. With respect to rear ground-engaging members 12, as force F is applied to brake member 54, brake master cylinder 56 provides an input to rear master cylinder output 147 to initiate a flow of hydraulic fluid to input 149 through rear left channel 144, first junction conduit 74a, junction member 72, and rear left conduit 68 to rear left ground-engaging member 12. Additionally, the input provided to rear master cylinder output 147 from brake master cylinder 56 also initiates a flow of hydraulic fluid through rear right channel 146, second junction conduit 74b, junction member 72, and rear right conduit 70 to rear right ground-engaging member 12. In this way, a single actuation of braking assembly 40 when the operator depresses brake member 54 allows for braking of all ground-engaging members 10, 12 through the four channels 140, 142, 144, 146 of HECU 60. It may be appreciated that, in certain modes, the HECU 60 may control the flow of hydraulic fluid to any of the brake calipers 48 or 52. For example, as described below, the HECU 60 may initiate a flow to one or more brake calipers of the vehicle 2. For instance, to allow for better and/or smaller turning radiuses, the HECU 60 may slow down the inner rear ground-engaging member 12a (e.g., initiate flow of hydraulic fluid to only 52a) while the speed of the outer rear ground-engaging member 12b increases in response to the decreased speed of the inner rear ground-engaging member 12a. Additionally, or alternatively, the HECU 60 may slow down the inner front ground-engaging member 10a (e.g., initiate flow of hydraulic fluid to only 52a) while the speed of the outer front ground-engaging member 10b increases in response to the decreased speed of the inner front ground-engaging members 10a. By slowing down the inner rear ground-engaging member 12a and/or the inner front ground-engaging member 10a, the HECU 60 may cause the vehicle 2 to achieve better and/or smaller turning radiuses.

Referring now to FIG. 10, the HECU 60 and/or controller 222 may be connected to a plurality of devices, sensors, and/or sub-systems of vehicle 2. In an illustrated embodiment of the present disclosure, the HECU 60 and/or controller 222 is connected and/or in communication with a plurality of devices, sensors, and/or sub-systems such as the controller 222, a battery 202, a user interface 204, a display 124, a brake calipers 48, 52, a gear selection 206, a wheel speed sensor(s) 80, 90, a throttle pedal position 208, a brake sensor 210, an inertial measurement unit (IMU) 212, a steering sensor 236, a vehicle speed sensor 214, the brake master cylinder 56, an engine speed sensor 220, a suspension controller 218, a transmission controller 216, and/or a global positioning system (GPS) sensor(s) 221. For example, the HECU 60 and/or controller 222 may be in electrical communication (e.g., transmits and/or receives information) with the devices, sensors, and/or sub-systems of vehicle 2. The HECU 60 and/or controller 222 may communicate with the sensors, devices, and/or sub-systems via a bus (e.g., a data bus) and/or wirelessly. Additionally, or alternatively, the HECU 60 may be hydraulically connected to the devices, sensors, and/or sub-systems of vehicle 2. For example, the HECU 60 and/or controller 222 may be hydraulically and/or electrically connected to the brake master cylinder 56 and/or the brake calipers 48, 52. As mentioned previously, the brake calipers 48 or 52 may be connected to the front ground-engaging member(s) 10 and/or the rear ground-engaging members 12. In embodiments, each of left front, right front, left rear, and right rear ground-engaging members have an associated brake caliper controlled by HECU 60 and/or controller 222. In some instances, the controller 222 may include one or more controllers and/or units, such as the transmission controller 216, the suspension controller 218, and/or the HECU 60. In other instances, the controller 222, the transmission controller 216, the suspension controller 218, and/or the HECU 60 may be a collection of controllers. Additionally, or alternatively, these controllers/units 60, 218, 216, 222 and/or additional controllers and units may work together to implement and/or perform the logic or blocks described below. In embodiments when powertrain assembly 30 includes an electric motor, a high-voltage battery (not shown) may also include a battery control module (BCM) and a motor controller configured to provide instructions to the electric motor.

Referring now to the devices, sensors, and/or sub-systems of vehicle 2, a user interface 204 is provided in a location easily accessible to the driver operating the vehicle 2. In some embodiments, the display 124 described above may be integrated with the user interface 204. User interface 204 (e.g., display 124) includes user input devices to allow the driver or a passenger to manually adjust HECU intervention modes described below during and/or before the operation of the vehicle 2.

Exemplary input devices for user interfaces 204 include levers, buttons, switches, soft keys, and other suitable input devices. User interface 204 may also include output devices to communicate information to the operator. Exemplary output devices include lights, displays, audio devices, tactile devices, and other suitable output devices. In another illustrated embodiment, the user input and/or output devices of the user interface 204 may be on a steering wheel, handlebar, and/or other steering control of the vehicle 2.

In some embodiments, the display 124 may be coupled to one or more cameras 125. The camera(s) 125 may be integrated into the all-terrain vehicle 2 in order to image and/or record the surroundings of the vehicle 2. The images and/or recordings produced by the camera(s) 125 may be used by the user operating the vehicle 2 to view any blind spots of the user of the vehicle 102 and/or make it easier for the user to view the user's surroundings. According to some embodiments, the camera(s) 125 may include one or more front-facing cameras, one or more side-facing cameras, and/or one or more rear-facing cameras. The rear-facing camera(s) may be used to view what is behind the vehicle 2 when the vehicle 2 is intentionally (e.g., when the transmission system 217 is in reverse gear) or unintentionally moving backwards (e.g., when the transmission system 217 is not a reverse gear).

According to some embodiments, the display 124 and the user interface 204 may be separate (e.g., the user interface 204 is mounted adjacent the driver's seat on the dashboard of the vehicle 2 and next to the display 124 shown in FIG. 1). The display 124 may display information related to the HECU intervention modes, and the user interface 204 may include input and output devices as described above.

According to certain embodiments, the transmission controller 216 may control the transmission system 217 of vehicle 2. For example, the transmission controller 216 may transmit information to the HECU 60 or controller 222 such as gear position of the transmission system 217 (e.g., drive, neutral, reverse, and/or park), differential status (e.g., locked, unlocked, smart locking (i.e., controlled slip)), and/or wheel torque. The HECU 60 or controller 222, in response to the transmitted information, may generate one or more signals and may transmit them back to the transmission controller 216.

According to certain embodiments, the GPS sensor(s) 221 may determine coordinates of the all-terrain vehicle 2 and may facilitate determining whether the vehicle 2 is stationary or moving. Whether the vehicle 2 is moving or stationary may be used in one or more of the embodiments described below. While the GPS sensor(s) 221 are illustrated as being coupled to the HECU 60, the GPS sensor(s) 221 may additionally or alternatively be communicatively coupled to one or more other controllers and/or units of the vehicle 2, such as controller 222 (FIG. 11).

According to certain embodiments, the IMU 212 may include a plurality of IMUs 212 such that each IMU 212 is arranged on the vehicle 2 to sense inertial magnitudes in the x-direction, y-direction, and/or z-direction, respectively. As such, the IMUs 212 may be used to determine a pitch angle and/or roll angle of the all-terrain vehicle 2. Exemplary IMUs 212 include accelerometers, gyroscopes, and other suitable sensors. Exemplary sensors and monitoring systems are disclosed in U.S. patent application Ser. No. 15/816,368, filed Nov. 17, 2017, titled VEHICLE HAVING ADJUSTABLE SUSPENSION, docket PLR-15-25091.08P-US-e, the entire disclosure of which is expressly incorporated herein by reference.

Referring now to FIG. 11, electronic controller 222 is operable to receive information from a plurality of sensors, components, or vehicle subassemblies. Vehicle 2 may be configured to operate in a plurality of drive modes 224 which may be selectable by a user by one or more user inputs (not shown). Drive modes may include a rock mode, a trail mode, a comfort mode, a race mode, a baja mode, or other types of modes. Vehicle 2 may also be configured to operate in a plurality of drive configurations 226 that determine which, if any, of the ground engaging members 10, 12 are intended to receive power from powertrain assembly 30. In embodiments, controller 222 may be configured to alter which drive configuration 226 vehicle 2 is operating in by a user input or automatically by one or more of the plurality of sensors. In various embodiments, vehicle 2 may be configured to operate in a variety of drive configurations, including a turf mode (i.e., 1×4), a two-wheel drive mode (i.e., 2×4), a three-wheel drive mode (i.e., 3×4), a four-wheel drive mode (i.e., 4×4), and/or an All-Wheel Drive (AWD) mode. In various embodiments, additional drive modes may be indicative of an open/closed configuration of one or both of front final drive member 36 and rear final drive member 34. Additional details regarding drive configurations vehicle 2 may operate in are found in U.S. patent application Ser. No. 17/235,322, filed Apr. 20, 2021, titled SYSTEMS AND METHODS FOR OPERATING AN ALL-TERRAIN VEHICLE, attorney docket no. PLR-15-29107.02P-US, the entire disclosure of which is expressly incorporated herein by reference.

Still referring to FIG. 11, electronic controller 222 may be operatively coupled to inertial measurement unit (“IMU”) 212, an accelerometer 228 and a gyroscope 230. Accelerometer 228 and gyroscope 230, in embodiments are part of IMU 212. An exemplary IMU 212 is a three-axis system including three orthogonal accelerometers and associated gyroscopes. Accelerometer 228 may be configured to provide linear acceleration values of vehicle 2 including a lateral acceleration, longitudinal acceleration, and vertical acceleration. Gyroscope 230 may be configured to provide or determine angular velocity and angular acceleration including a yaw rate, a pitch rate, and a roll rate. Vehicle 2 may also be coupled with one or more suspension sensors 234 operably coupled to suspensions 27, 28. In examples, suspensions 27, 28 comprise one or more shock absorbers, springs, or other linear force elements configured to dampen forces between suspensions 27, 28 and frame 4. One or both of suspensions 27, 28 may include a suspension sensor 234 which may be configured to measure a shock position, a shock and spring force, a shock force, a shock velocity, a shock temperature, or another suspension characteristic. Additional details pertaining to suspensions may be found in U.S. patent application Ser. No. 16/198,280, filed Nov. 21, 2018, issued as U.S. Pat. No. 10,987,987 on Apr. 27, 2021, titled VEHICLE HAVING ADJUSTABLE COMPRESSION AND REBOUND DAMPING, attorney docket no. PLR-15-28021.01P-US; U.S. patent application Ser. No. 17/379,675, filed Jul. 19, 2021, published as U.S. Publication No. 2022/0016949A1 on Jan. 20, 2022, titled ADJUSTABLE SUSPENSIONS AND VEHICLE OPERATION FOR OFF-ROAD RECREATIONAL VEHICLES, attorney docket no. PLR-15-29249.04P-US; and U.S. patent application Ser. No. 17/325,062, filed May 19, 2021, published as U.S. Publication No. 2021/0362806A1 on Nov. 25, 2021, titled SYSTEMS AND METHODS OF ADJUSTABLE SUSPENSIONS FOR OFF-ROAD RECREATIONAL VEHICLES, attorney docket no. PLR-01-29147.02P-US, the entire disclosures of which are expressly incorporated herein by reference.

Still referring to FIG. 11, controller 222 may also be coupled to power steering unit 29 (FIG. 12) which may be configured to provide a torque assistance between the steering input 25 and at least one of the front ground engaging members 10 and rear ground engaging members 12. In embodiments, power steering unit 29 comprises a motor 33 (FIG. 12) configured to provide a steering torque to a steering shaft 35 and a steering rack 31 operably coupled to front ground engaging members 10. Controller 222 may be operably coupled to a steering sensor 236 configured to monitor a steering characteristic. Exemplary steering characteristics include a torque experienced by steering assembly 26, a steering angle, or a speed of the motor 33. In embodiments, steering sensor 236 is a torque sensor within motor 33, a torque sensor on steering shaft 35 (e.g., strain gauge), or a linear force sensor positioned on one of halfshafts 37, 38. In embodiments, steering sensor 236 is a hall effect sensor, a visual sensor, or another type of sensor configured to measure the rotational speed of motor 33. Steering sensor 236 may be configured to provide one or both of a steering angle position (i.e., rad or deg) and a steering angle velocity (i.e., rad/s or deg/s) or steering angle acceleration (i.e., rad/s\hat{ }2 or deg/s\hat{ }2). In embodiments, steering sensor 236 may be positioned within motor 33, along steering shaft 35, along halfshafts 37, 38, adjacent any of ground engaging members 10, 12, or otherwise operably coupled to steering assembly 26. In embodiments, steering sensor 236 is a plurality of sensors configured to measure a plurality of steering characteristics, as described herein. In embodiments, controller 222 may be configured to monitor a current (A) and voltage (V) of power steering motor 33.

In embodiments, powertrain 30 includes one or more electric motors, and controller 222 may be operably coupled to one or more sensors configured to monitor a motor characteristic. Exemplary motor characteristics include a motor speed, a motor temperature, a motor torque, a motor acceleration, a motor current, a motor voltage, a motor direction, a magnetic flux, or another motor value.

In embodiments, controller 222 is operable to monitor other sensors, and receive other information from at least a throttle position sensor 208, a vehicle speed sensor 214, GPS 221, wheel speed sensors 80, 90, and brake sensor 210. In embodiments, controller 222 is operably coupled to prime mover speed sensor 240 and configured to monitor a speed of the prime mover (e.g., internal combustion engine, electric motor, etc.). Controller 222 may also be configured to monitor a frequency characteristic, or frequency response, of any of the sensors configured to monitor vehicle 2. That is, a frequency of any vehicle characteristic (e.g., lateral acceleration, vertical acceleration, power steering torque, etc.) may be monitored and compared against stored values. In embodiments, low frequency characteristics may be monitored between 0 Hz-3 Hz, and in embodiments, high frequency characteristics may be monitored between 3 Hz-10 Hz. In embodiments, characteristics of vehicle 2 may be monitored at higher frequencies such as 10 Hz or greater. In embodiments, controller 222 is operably coupled to one or more vision sensors 340. Vision sensors 340 may include cameras, radar sensors, infrared sensors, LiDar sensors, ultrasonic sensors, sonar sensors, or other types of vision sensors. As shown in FIG. 11, controller 222 may be coupled to one vision sensor 340, two vision sensors 340, three vision sensors, or more vision sensors. In embodiments, controller 222 is coupled to a plurality of different types of vision sensors 340 (e.g., a camera and a radar sensor; a infrared sensor and a sonar sensor). In embodiments, one or more of the vision sensors 340 are operably coupled to brake controller 60.

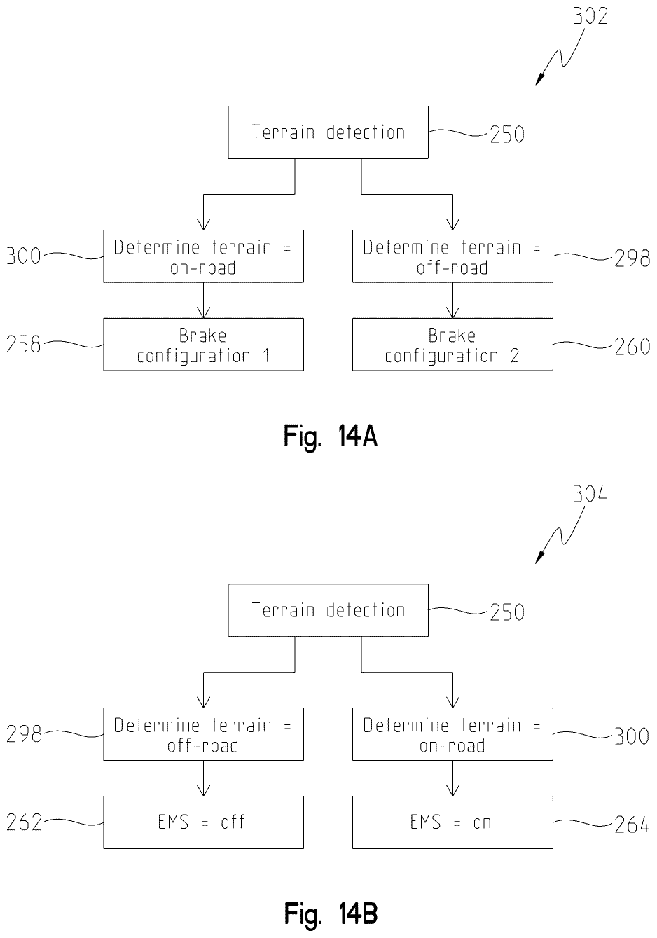

Still referring to FIG. 11, HECU 60 or electronic controller 222 may be configured to complete, or determine, a terrain detection process 250. Further, electronic controller 222 may be coupled to brake controller 60, and brake controller 60 may be configured to operate according to a plurality of brake configurations. That is, either electronic controller 222 or brake controller 60 may be configured to execute one or more operating instructions provided by, or according to, a brake configuration table 256. In embodiments, brake configuration table 256 is configured to operate in a first brake configuration, or an anti-lock braking (ABS) configuration 258 (FIG. 14A) and an adaptive anti-lock braking (adaptive ABS) configuration 260 (FIG. 14B). Controller 222 may also be operably coupled to a separate stability controller 252 which is operably coupled to one or more vehicle subsystems (e.g., braking system 40, steering assembly 26, suspension assembly 27, 28). Stability controller 252 may be a separate controller or may also be included with electronic controller 222. Stability controller 252 may be configured to execute one or more operating instructions provided by, or according to, a stability control table 254. Stability controller 252 may be configured to operate vehicle 2 (or vehicle subsystems) according to an Evasive Maneuver Stabilization (EMS) mode, which may provide vehicle interventions based upon one or more vehicle sensors and/or user inputs.

In embodiments, Evasive Maneuver Stabilization (EMS) mode is configured to provide vehicle interventions (e.g., brake adjustments, suspension adjustments, steering adjustments, powertrain adjustments, etc.) in response to one or more controllers determining vehicle 2 is in a predetermined condition based upon the values of one or more sensors monitored against stability control table(s) 254. That is, in one embodiment, stability controller 252 (or controller 222) is configured to monitor one or more sensors of vehicle 2, and in response to a sensor value, or a plurality of sensor values, controller 252, 222 is configured to adjust an operating characteristic of at least one of the brake assembly 40, suspension assembly 27, 28, steering assembly 26, and powertrain assembly 30. In embodiments, controller 252, 222 is configured to receive a steering angle position value from steering sensor 236, a steering angle rate value from steering sensor 236, a vehicle speed 214, and in response to the steering angle position being greater than a first steering angle threshold, the steering angle rate being greater than a first steering angle rate threshold, and vehicle speed 214 being greater than a first vehicle speed threshold, controller 252, 222 is configured to engage one or more of the brakes associated with any of ground engaging members 10, 12. In embodiments, controller 252, 222 monitors each input (e.g., steering position, steering rate, vehicle speed) and compares each input to stability control table(s) 254, and for any given value for any input (e.g., steering position, steering rate, vehicle speed), a prescribed output is provided by stability control table(s) 254. In embodiments, if controller 252, 222 determines that a user has turned the steering input 25 to the left, the vehicle speed is greater than 25 miles per hour (mph), steering angle position is greater than 120 degrees, and steering angle rate is greater than 550 degrees per second, controller 252, 222 will feed these inputs into stability control table(s) 254 and automatically adjust brake assembly 40 so that brake pressure is applied to one or both of front right brake 48b or rear right brake 52b. In embodiments, brake pressure is applied to only front right brake 48b. In embodiments, brake pressure is applied to only front left brake 48a and front right brake 48b.

In various embodiments, controller 252, 222 may adjust, in response to monitoring any of the sensors on vehicle 2, a brake pressure of any one of front left brake 48a, front right brake 48b, rear left brake 52a, rear right brake 52b, or may also adjust a damping level of either of suspensions 27, 28, or a damping level associated with a shock absorber cooperating with any of front left ground engaging member 10, front right ground engaging member 10, rear left ground engaging member 12, or rear right ground engaging member 12. Controller 252, 222 may also adjust, in response to monitoring any of the sensors on vehicle 2, an operating characteristic of powertrain 30 (e.g., prime mover speed 240), or an operating characteristic of steering assembly 26 (e.g., torque assist).

In embodiments, controller 252, 222 may operate vehicle 2 with Evasive Maneuver Stabilization (EMS) in an ON-condition 264 (FIG. 14B). In embodiments with EMS in an ON-condition 264, in response to monitoring any of the sensors on vehicle 2, controller 252, 222 may adjust an operating condition of any one of vehicle subsystems (e.g., brake assembly 40, suspension assemblies 27, 28, steering assembly 26, powertrain assembly 30). In embodiments with EMS in an ON-condition 264, in response to monitoring any of the sensors on vehicle 2, controller 252, 222 may adjust an operating condition of any one of the one or more electric motors of an electric powertrain 30. In embodiments, controller 252, 222 may operate vehicle 2 with EMS in an OFF-condition 262 (FIG. 14B), wherein in response to monitoring any of the sensors on vehicle 2, controller 252, 222 may provide no adjustments to vehicle subsystems or fewer adjustments (i.e., a limited-condition) than when EMS is in an ON-condition 264. In embodiments, a user may determine when EMS is activated by a user input. In embodiments, controller 252, 222 may automatically switch EMS between an OFF-condition 262 and an ON-condition 264, or between an ON-condition 264 and an OFF-condition 262. In embodiments, controller 252, 222 is configured to automatically adjust EMS between an ON-condition 264, OFF-condition 262, or limited condition based upon a drive mode 224, a drive configuration 226, or based upon a detected terrain from terrain detection process 250.

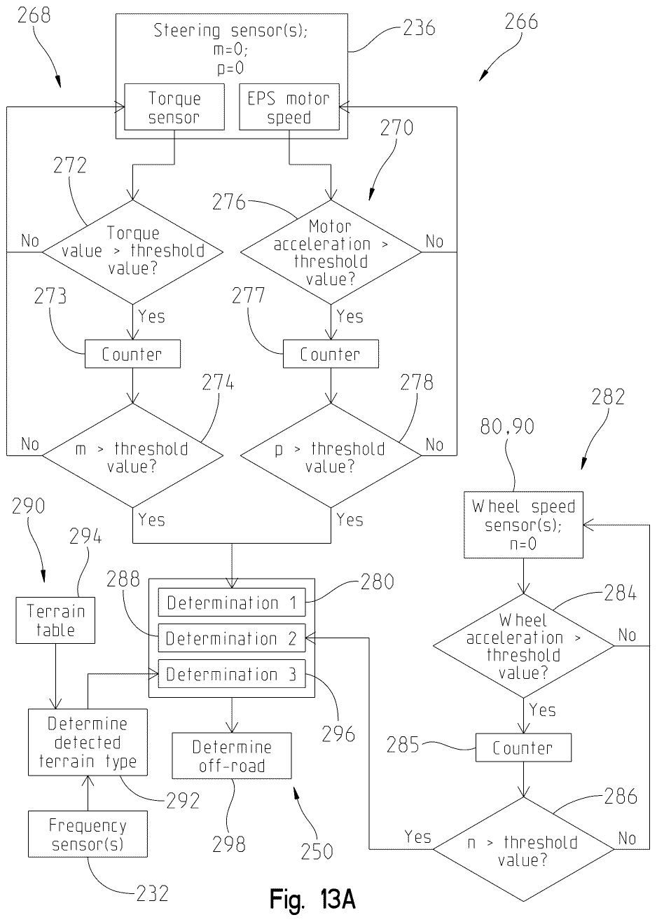

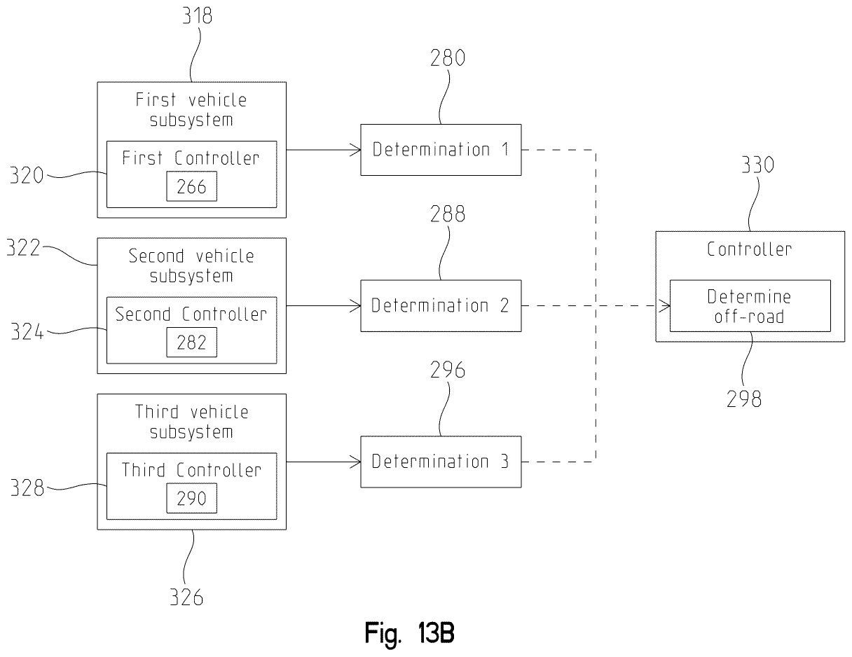

Referring now to FIG. 13A, a terrain detection process 250 is shown. Terrain detection process 250 includes a plurality of determination processes which individually provide an indication of terrain type, illustratively a first determination process 266, a second determination process 282, and a third determination process 290. Controller 222 may determine the vehicle is off-road in response to any one of the plurality of determination processes or based on a collection of the determination processes. For example, controller 222 may determine the vehicle is off-road if a majority of the determination processes, illustratively two of the three determination processes, indicate the vehicle is off-road. In another example, each determination process may provide a confidence value that the vehicle is off-road and controller determines the vehicle is off-road if an average of the confidence values satisfies a threshold. In another example, each determination process may provide a confidence value that the vehicle is off-road and controller determines the vehicle is off-road if a summation of the confidence values satisfies a threshold.

In embodiments, first determination process 266 is configured to provide a first determination of a terrain type based upon inputs from steering assembly 26 (e.g., steering sensor(s) 236). First determination process 266 includes a first subprocess 268 and a second subprocess 270. In subprocess 268, controller 222 is configured to monitor a torque by steering sensor 236 and in decision block 272, controller 222 determines if the torque value monitored by the steering sensor 236 has reached, or exceeded, a torque threshold value. In embodiments, controller 222 compares the torque value monitored by the steering sensor 236 to one or more threshold values. Subprocess 268 includes a counter 273 positioned intermediate block 272 and a block 274, and each time the torque value monitored by the torque sensor 236 (e.g., steering sensor(s) 236) exceeds the torque threshold value, counter 273 adds a value representative of the torque value to the previous summation of values, creating a dynamic summation. Subsequently, decision block 274 determines if the counter value 273 (e.g., dynamic summation) has exceeded or passed one or more threshold levels, which will be explained in greater detail below. In embodiments, decision block 274 determines if the number of times the torque threshold value has been exceeded is greater than a first predetermined number of times. The one or more threshold levels may be a factory-selected number (i.e., predetermined by the Original Equipment Manufacturer (OEM)), or may otherwise be a selectable, or tunable number by a dealer, owner, or operator of vehicle 2. In embodiments, subprocess 268 is continuous. In embodiments, subprocess 268 continues until the number of times the torque threshold value has been exceeded is greater than the first predetermined number of times. In embodiments, subprocess 268 is configured to measure a torque gradient between steering torque values measured by sensor 236, and a controller (e.g., controller 222) is configured to compare the torque gradient against the one or more thresholds.

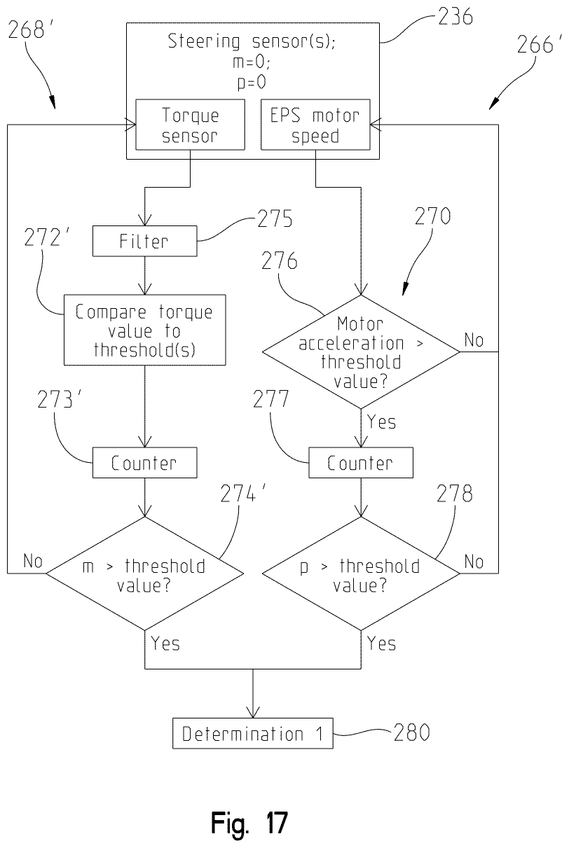

Referring to FIG. 17, a determination process 266′ may replace first determination process 266 within terrain detection process 250. Determination process 266, 266′ looks for, by controller 222, variation in one or both of the power steering velocity and steering torque of the steering assembly (e.g., movement of the steering assembly of the vehicle resulting from the terrain the vehicle is moving across). Further, determination process 266, 266′ may evaluate surface uniformity by analyzing the profile of the variations (e.g., a noise data noise profile) in the power steering velocity and steering torque of the steering assembly. Further, determination process 266, 266′ may differentiate between and determine an off-road or on-road terrain based upon the profile of the variations (e.g., a data noise profile). In embodiments, controller 222 may determine an off-road or on-road terrain based upon the length of time of the profile of the variations (e.g., a data noise profile). In embodiments, controller 222 may determine an off-road or on-road terrain based upon the amplitude of the variations within the profile (e.g., a data noise profile). Determination process 266′ includes a first subprocess 268′ and second subprocess 270 (as described above). In first subprocess 268′, controller 222 is configured to monitor a torque by steering sensor 236 and analyze data through a filter 275. In embodiments, filter 275 is a bandpass filter, a low-pass filter, a high-pass filter, a fast Fourier transform, or another type of filter. In embodiments, filter 275 is configured to filter out all torque values that are recorded at less than a frequency threshold (e.g., below 5 Hz). That is, subprocess 268′ takes input data from torque sensor (e.g., steering sensors 236) which includes ‘expected inputs’ (e.g., driver steering torque inputs or driver generated frequency inputs) and ‘unexpected inputs’ (e.g., torque spikes). In embodiments, the ‘expected inputs’ are generally inputs that have a frequency below a predetermined threshold (e.g., below 5 Hz) and the ‘unexpected inputs’ are generally inputs that have a frequency above a predetermined threshold (e.g., above 5 Hz). Filter 275 takes out all inputs below the predetermined frequency to generally filter out all, or most, ‘expected inputs’ (e.g., driver steering inputs). Referring still to FIG. 17, determination process 268′ determines if the filtered torque value monitored by the steering sensor 236 has reached, or exceeded, a torque threshold, as referenced in block 272′. In embodiments, controller 222 compares the filtered torque value monitored by the steering sensor 236 and filtered by filter 275 to one or more threshold values. Subprocess 268′ generally includes counting the number of times the filtered torque value has met or exceeded a torque threshold, as referenced by a counter 273′. That is, each time the torque value monitored by the torque sensor 236 exceeds the torque threshold value, counter 273′ adds a value representative of the torque value to the previous summation of values, creating a dynamic summation. Subsequently, subprocess 268′ determines if the counter value 273′ has exceeded or passed one or more threshold levels, as identified in block 274, 274′. In embodiments, block 274, 274′ determines if the number of times the torque threshold value has been exceeded is greater than a first predetermined number of times. The one or more threshold levels may be a factory-selected number (i.e., predetermined by the Original Equipment Manufacturer (OEM)), or may otherwise be a selectable, or tunable number by a dealer, owner, or operator of vehicle 2. In embodiments, subprocess 268′ is continuous. In embodiments, subprocess 268′ continues until the number of times the torque threshold value has been exceeded is greater than the first predetermined number of times. In embodiments, subprocess 268′ is configured to measure a torque gradient between steering torque values measured by sensor 236, and a controller (e.g., controller 222) is configured to compare the torque gradient against the one or more thresholds and may filter the torque gradient with filter 275. In embodiments, the counter is configured to reset (e.g., to zero, or another predetermined number) each time vehicle 2 is turned OFF, or each time that vehicle 2 is still for a predetermined amount of time (e.g., 2-3 minutes). In embodiments, controller 222, when turned on, always initializes to an off-road determination and may approach an on-road condition.

In embodiments, referring still to FIG. 17 and as referenced in block 272′, the filtered torque values may be compared to one or more torque threshold values, including a first threshold, a second threshold greater than the first threshold, and a third threshold greater than the second threshold. In embodiments, the torque range between the first torque threshold and the second torque threshold defines a first range, the torque range between the second torque threshold and the third torque threshold defines a second range, and values represented above the third torque threshold define a third range. In embodiments, filtered torque values from filter 275 fall within the ranges (e.g., first range, the second range, and the third range) and values falling within the various ranges may have different weights when counted by counter 273′. In embodiments, filtered torque values that fall within the first range have a first ‘counter value’, filtered torque values that fall within the second range have a second ‘counter value’, and filtered torque values that fall within the third range have a third ‘counter value’. Counter 273′ counts the respective ‘counter value’ associated with each filtered torque value (e.g., first ‘counter value’, second ‘counter value’, and third ‘counter value’) and creates a dynamic summation, and subprocess 268′ compares the dynamic summation to a threshold value, as referenced in block 274′, as will be described in greater detail below. In embodiments, the torque range below the first torque threshold defines a fourth range, and filtered torque values that fall within the fourth range have a fourth ‘counter value’ that is less than each of the first ‘counter value’, second ‘counter value’, and third ‘counter value’. In embodiments, counter 273, 273′ uses an additive mathematical operation. In embodiments, counter 273, 273′ uses an integral mathematical operator, or another type of mathematical operator.

Referring again to FIG. 13A, in subprocess 270 of process 266, 266′ controller 222 is configured to monitor a speed of power steering motor 33 by steering sensor 236 and in decision block 276, controller 222 determines if the motor speed monitored by the sensor 236 is greater than a power steering motor speed threshold value. In embodiments, controller 222 is configured to determine if the motor acceleration monitored by the sensor 236 is greater than a power steering motor acceleration threshold value. Subprocess 270 includes a counter 277, and each time the motor speed value monitored by the sensor 236 exceeds the power steering motor speed threshold value, counter 277 adds a value representative of the speed or acceleration value to the previous summation of values creating a dynamic summation. Subsequently, decision block 278 determines if the counter value 277 has exceeded or passed one or more threshold levels, which will be explained in greater detail below. In embodiments, decision block 278 determines if the number of times the steering motor speed threshold value or steering motor acceleration threshold value has been exceeded is greater than a second predetermined number of times. In embodiments, subprocess 270 is continuously run. In embodiments, subprocess 270 continues until the number of times the power steering motor speed threshold value or power steering motor acceleration threshold value has been exceeded is greater than the second predetermined number of times.

In embodiments, process 266, 266′ is configured to determine that vehicle 2 is in an off-road terrain when subprocess 268 (or subprocess 268′) has determined that the counter value 273, 273′ has exceeded an off-road threshold and when subprocess 270 has determined that the counter value 277 has exceeded an off-road threshold. In embodiments, process 266, 266′ is configured to determine that vehicle 2 is in an off-road terrain when subprocess 268 (or subprocess 268′) has determined that the number of times the torque threshold value has been exceeded is greater than a first predetermined number of times and when subprocess 270 has determined that the number of times the power steering motor speed threshold value has been exceeded is greater than a second predetermined number of times. When process 266 determines that both the first subprocess 268 (or subprocess 268′) and second subprocess 270 have been completed, or that the counter 273 (or counter 273′), 277 of each subprocess 268, 270 (or subprocess 268′) has exceeded the respective off-road threshold level, controller 222 makes a first determination, or ‘Determination 1’ 280 that vehicle 2 is in an off-road condition. In embodiments, controller 222 is configured to make the first determination 280 when either of subprocess 268 (or subprocess 268′) or subprocess 270 is completed.

Still referring to FIG. 13A, in second determination process 282, controller 222 is configured to monitor wheel speed sensors 80, 90 to determine a wheel speed, and may also monitor, or determine, a wheel acceleration value, or another wheel movement value. In decision block 284 of second determination process 282, controller 222 is configured to determine if a wheel acceleration value experienced by any one of wheels, or ground engaging members 10, 12, is greater than a wheel acceleration threshold value. In embodiments, second determination process 282 includes a counter 285 and each time the wheel acceleration value monitored by wheel speed sensors 80, 90 exceeds the wheel acceleration threshold value, counter 285 adds a value, representative of the wheel acceleration value, to the previous summation of values. Subsequently, decision block 286 determines if the counter value 285 has exceeded or passed one or more threshold levels, which will be explained in greater detail below. In embodiments, decision block 286 determines if the number of times the wheel acceleration threshold value has been exceeded is greater than a third predetermined number of times. If controller 222 determines that either the counter 285 has passed one or more of the threshold values, or if the number of times the wheel acceleration threshold value has been exceeded is greater than the third predetermined number of times, second determination process 282 is completed, or makes the off-road determination, and controller 222 makes a second determination, or ‘Determination 2’ 288 that vehicle 2 is in an off-road condition. In embodiments, process 282 is continuously run. In embodiments, process 282 continues until the number of times the wheel acceleration threshold value has been exceeded is greater than the third predetermined number of times.

In embodiments, in second determination process 282, controller 222 only monitors wheel speed sensors 80 of front ground engaging members 10. In embodiments, in second determination process 282, controller 222 only monitors wheel speed sensors 90 of rear ground engaging members 10. In embodiments, in second determination process 282, controller 222 monitors one or more of wheel speed sensors 80, 90 of ground engaging members 10, 12. In embodiments, during second determination process 282, controller 222 only monitors wheel speed sensors 80,90 for wheel acceleration values that exceed wheel acceleration threshold values when brake assembly 40 is not activated.

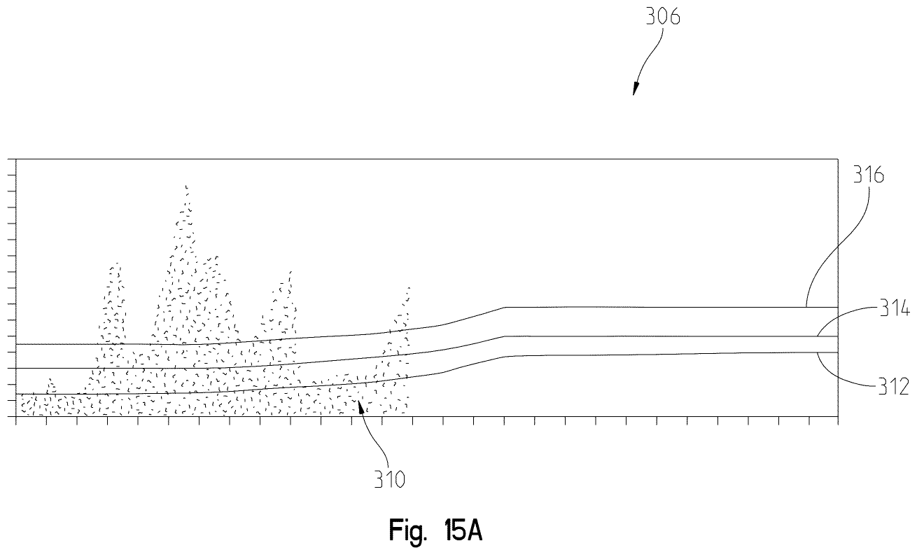

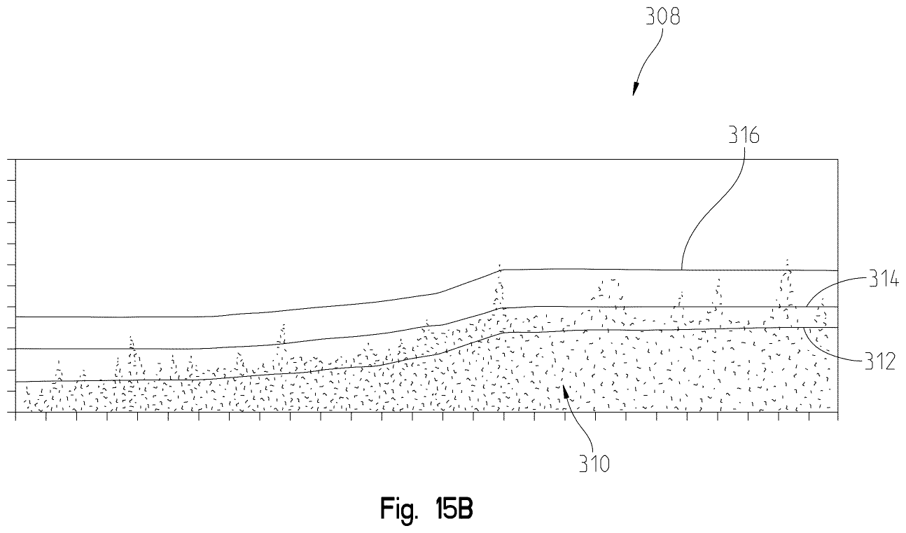

Referring to FIGS. 15A and 15B, a plot 306 and a plot 308 are provided which display a plurality of data points 310. In embodiments, data points 310 are wheel speed acceleration values from process 282. In embodiments, data points 310 are torque values from process 268, 268′ or motor acceleration values from process 270. In embodiments, data points 310 are torque gradient values from process 268, 268′. In embodiments, data points 310 are values representative of an operating characteristic of one or more electric motors of electric powertrain assembly 30. Illustratively, plot 306 is illustrative of an off-road terrain, or off-road condition and plot 308 is illustrative of an on-road terrain, or on-road condition. Illustratively, plots 306, 308 provide a plurality of thresholds, including a lower threshold 312, an intermediate threshold 314, and an upper threshold 316. Thresholds 312, 314, 316 are configured to provide relational values to data points 310, and weight them between an on-road configuration and an off-road configuration. In embodiments, if a data point 310 is greater than, or higher than, the upper threshold 316, the data point 310 is weighted greater than a data point 310 lower than upper threshold 316. In embodiments, a data point 310 that is greater than, or higher than, the upper threshold 316 may be indicative of a larger event (e.g., a rougher surface, such as a large bump, a large pothole, or other large obstacle) and is counted towards an off-road determination. In embodiments, a data point 310 that is between intermediate threshold 314 and an upper threshold 316 may be counted towards an off-road determination but may be weighted less than a data point 310 that is greater than upper threshold 316. In embodiments, a data point 310 that is between lower threshold 312 and intermediate threshold 314 may be considered a neutral data point 310 and may be counted towards a ‘hold’ event to maintain the current terrain determined, or in-use by controller 222. In embodiments, a data point 310 that is lower than lower threshold 312 may be indicative of an on-road condition (i.e., a smoother surface).

In embodiments, referring to process 268, 268′, controller 222 (or another controller, e.g., a steering controller) may be configured to monitor torque values, and determine a torque gradient value between the monitored torque values. That is, the torque gradient value may be the difference between a pair of neighboring torque values, for example, at a first time, the first torque value is X, at a second time, the second torque value is Y, and the torque gradient equals Y minus X. In embodiments, each torque gradient determined is a data point 310 on each of plots 306, 308. Further, counter 273, 273′ is configured to monitor, and count, the value of each data point 310 and compare the value of the counter 273, 273′ to a plurality of engagement thresholds.

In embodiments, referring to process 270, controller 222 (or another controller, e.g., a steering controller) may be configured to monitor motor speed, or motor acceleration values. In embodiments, each motor acceleration value monitored is a data point 310 on each of plots 306, 308. Further, counter 277 is configured to monitor, and count, the value of each data point 310 and compare the value of the counter 277 to a plurality of engagement thresholds.

In embodiments, referring to process 282, controller 222 (or another controller, e.g., brake controller 60) may be configured to monitor a wheel speed acceleration value by wheel speed sensors 80, 90. In embodiments, each wheel speed acceleration value is a data point 310 on each of plots 306, 308. Further, counter 285 is configured to monitor, and count, the value of each data point 310 and compare the value of the counter 285 to a plurality of engagement thresholds.

In embodiments, any sensor value from any sensor disclosed herein may be monitored by controller 222, and data points 310 on either plot 306, 308 may be representative of any sensor value of a sensor disclosed herein, or a transformation or filter of any sensor value.

Still referring to FIGS. 15A and 15B, plots 306 and 308 may be representative of plots that may be used to compare values from any of subprocess 268, 268′, subprocess 270, or process 282. That is, in embodiments, with reference to subprocess 268, 268′, each data point 310 may be representative of a torque gradient value, as previously described. Further, each data point 310 may be weighted to count as a determined value (e.g., the ‘counter value’) depending upon where the data point 310 lies relative to each threshold (e.g., thresholds 312, 314, 316), and counter 273, 273′ may count, and add, the determined value (e.g., the ‘counter value’) for each data point 310. In embodiments, referring to FIG. 15A, a data point 310 that lies above upper threshold 316 (e.g., the third range) may be worth (i.e., have a ‘counter value’ of) five (5) points, a data point 310 that lies above intermediate threshold 314 and below upper threshold 316 (e.g., the second range) may be worth (i.e., have a ‘counter value’ of) two-and-a-half (2.5) points, a data point 310 that lies between lower threshold 312 and intermediate threshold 314 (e.g., the first range) may be worth (i.e., have a ‘counter value’ of) 0 points, and a data point 310 that lies below lower threshold may be worth (i.e., have a ‘counter value’ of) negative one-half (−0.5) points. In embodiments, when vehicle 2 is started, counter 273, 273′ starts at 0 points, and controller 222 (or another controller, e.g., a steering controller) is configured to measure a torque gradient value every ten (10) milliseconds (ms) (i.e., 100 times per second). As vehicle 2 traverses a terrain, controller 222 detects torque gradient values, or data points 310 and plots them along a plot (e.g., plot 306) and compares each data point 310 to thresholds 312, 314, 316. That is, for example, a first data point 310 lies above upper threshold 316 (e.g., within the third range; valued at five (5) points), a second data point 310 lies above intermediate threshold 314 and below upper threshold 316 (e.g., within the second range; valued at two-and-a-half (2.5) points), a third data point 310 lies below lower threshold 312 (e.g., within the first range; valued at negative one-half (-0.5) points), and counter 273, 273′ will count ‘counter value’ of each of the first data point, second data point, and third data point to equal a total counter value (block 273, 273′) of seven (7) over the course of three cycles, or thirty (30) milliseconds.

In embodiments, controller 222 (or another controller, e.g., a steering controller) is configured to, in block 274, 274′ of process 268, 268′, compare the counter value (block 273, 273′) to one or more enablement threshold values. In embodiments, the plurality of enablement threshold values includes a ‘Disable’ Threshold (or ‘First’ Threshold), an ‘Enable’ Threshold (or ‘Second’ Threshold), and a ‘Saturation’ Threshold (or ‘Third’ Threshold). In embodiments, the ‘Disable’ Threshold is less than the ‘Enable’ Threshold, which is less than the ‘Saturation’ Threshold. In embodiments, the ‘Disable’ Threshold is two-hundred (200), the ‘Enable’ Threshold is three-hundred (300), and the ‘Saturation’ Threshold is four-hundred (400). Block 276 is configured to compare the counter value (block 273, 273′) to each of the ‘Disable’, ‘Enable’, and ‘Saturation’Thresholds.

In embodiments, when process 268, 268′ is active, counter 273, 273′ continues to count the determined values of each data point 310 (or torque gradient value), and when counter 273, 273′ reaches the ‘Second’ Threshold (i.e., 300 points), process 268, 268′ determines that vehicle 2 is in an off-road terrain. Process 268, 268′ is continuous and does not stop when the off-road determination is completed. That is, if process 268 has made an off-road determination, and vehicle 2 experiences a plurality of torque gradient values, or data points 310 that are under the lower threshold 312, counter 273, 273′ will decrease in value, and if counter 273, 273′ decreases in value below the ‘First’ Threshold (i.e., 200 points), controller 222 (or another controller), will determine vehicle 2 is in an on-road terrain, or condition. In embodiments, the ‘Third’ Threshold is configured as a maximum value of the counter 273, 273′, such that if vehicle 2 is continuously operating in an off-road condition, the counter 273, 273′ does not approach too great a number that reducing the counter value 273, 273′ to the ‘First’ Threshold would take too great of a time period in an on-road terrain, or condition.

Referring to FIG. 13A, any of counters 273, 273′ 277, 285 may be configured to operate according to the previously described operation of counter 273, 273′. In embodiments, the ‘Second’, ‘First’, and ‘Third’ Thresholds may be the same or different for each process 268, 270, 282. In embodiments, the ‘Second’, ‘First’, and ‘Third’ Thresholds are configurable by an OEM. In embodiments, a plurality of ‘sets’ of ‘First’, ‘Second’, and ‘Third’ Thresholds may be available to an operator of vehicle 2. In embodiments, the plurality of ‘sets’ may include a first set that is configured to transition between on-road and off-road configurations more quickly, a second set is configured to transition between on-road and off-road configurations less quickly, and a third set that is configured to transition between on-road and off-road configurations more quickly than the second set, but less quickly than the first set.

In embodiments, controller 222 (or another controller) is configured to assume an off-road starting determination (i.e., ‘Determination 1’ 280, ‘Determination 2’ 288, and ‘Determination 3’ 296) upon start-up. In embodiments, controller 222 is configured to store, or memorize, the current terrain determination (e.g., off-road or on-road) when vehicle 2 is keyed-off, or powered-off, and the next time vehicle 2 is keyed-on, or powered-on, controller 222 is configured to read, and maintain the latest terrain determination. For example, if vehicle 2 is powered-off on a paved road, or on-road terrain, and controller 222 has determined that vehicle 2 is traversing an on-road terrain through process 250, the next time vehicle 2 is powered-on, controller 222 will default to an on-road determination.

Referring again to FIG. 13A, in third determination process 290, controller 222 is configured to monitor a frequency response of one of a plurality of vehicle sensors (e.g., IMU 212, accelerometer 228, or gyroscope 230). In embodiments, controller 222 is configured to monitor the output of IMU 212 and monitor the output values to compare them to stored values representative of a certain terrain. In embodiments, the magnitude of low frequency values (i.e., from 0 Hz to 3 Hz) are compared to a low frequency threshold. If the magnitude of the low frequency values do not satisfy the low frequency threshold, then no event is detected, or it may be determined that the vehicle is on-road, or not off-road. If the magnitude of the low frequency values satisfy the low frequency threshold, then a first event, or a first type of terrain may be detected (e.g., the vehicle is, or may be, off-road). The magnitude of high frequency values (i.e., from 3 Hz to 20 Hz) are compared to a high frequency threshold. If the magnitude of the high frequency values do not satisfy the high frequency threshold, then no event is detected. If the magnitude of the high frequency value satisfies the high frequency threshold, a chatter event, or a second type of terrain may be detected (e.g., the vehicle is in an off-road condition).

In various embodiments, in third determination process 290, controller 222 is configured to monitor a frequency response of one of a plurality of vehicle sensors (e.g., IMU 212, accelerometer 228, or gyroscope 230). In embodiments, controller 222 is configured to monitor the output of IMU 212 and monitor the output frequency values to compare them to a single frequency threshold. If the magnitude of the frequency values are greater than the frequency threshold, a first event, or a first type of terrain may be detected (e.g., the vehicle is, or may be, off-road). In embodiments, third determination process 290 may include a single threshold or a plurality of thresholds, such as two thresholds, three thresholds, four thresholds, or more thresholds, and a confidence of the determination process 290 may be determined based upon where the discrete frequency values fall relative to the plurality of thresholds.

In embodiments, electronic controller 222 monitors the outputs of IMU 212 (a three-axis accelerometer and a three-axis gyroscope) to evaluate terrain and/or driver aggressiveness. Driver aggressiveness may be monitored by the longitudinal acceleration and lateral acceleration experienced by vehicle 2. Further, throttle position, brake pressure, and steering angle, and steering velocity may provide indicators. Terrain type may be monitored by longitudinal acceleration, lateral acceleration, vertical acceleration, and all three angular rates of IMU 212. In embodiments, the outputs are analyzed to determine the frequency response of each. The frequency responses may be determined through one or more bandpass filters, fast Fourier transform, or other methods. For example, the roll angular frequency response may be monitored with a bandpass filter for frequencies in a first range, such as 8-15 Hertz, to provide an indication of chatter. The monitored frequency response for one or more of the outputs are compared to stored ranges for different terrain types. Still referring to FIG. 13A, terrain tables 294 may provide predetermined values representative of the different terrain types, including on-road, gravel, snow, whoops, sand, or other types of terrain. In embodiments, terrain tables 294 may have stored ranges for both on-road and off-road terrains and may distinguish binarily between on-road and off-road.

Still referring to FIG. 13A, when third determination process 290 determines a terrain type (e.g., off-road or on-road) in block 292, the determined terrain is passed on to third determination, or ‘Determination 3’ block 296. In embodiments, controller 222 passes along an off-road condition to ‘Determination 3’ block 296.

Controller 222 is configured to monitor the status of each of ‘Determination 1’ 280, ‘Determination 2’ 288, and ‘Determination 3’ 296 and, in embodiments, when each of ‘Determination 1’ 280, ‘Determination 2’ 288, and ‘Determination 3’ 296 are an ‘off-road’ terrain type, terrain detection process 250 proceeds to block 298 and determines that vehicle 2 is in an off-road condition. Each process 266, 282, 290 is used to provide redundancy and confidence in the off-road determination in block 298. That is, in embodiments, process 266 and process 282 may determine, or detect, and off-road condition but process 290 does not determine an off-road condition, and therefore, an off-road condition is not determined, or detected, by process 250. In embodiments, process 290 and process 282 may determine, or detect, and off-road condition but process 266 does not determine an off-road condition, and therefore, an off-road condition is not determined, or detected, by process 250. In embodiments, process 290 and process 266 may determine, or detect, and off-road condition but process 282 does not determine an off-road condition, and therefore, an off-road condition is not determined, or detected, by process 250. In embodiments, process 290 determines, or detects, and off-road condition but processes 266 and 282 do not determine an off-road condition, and therefore, an off-road condition is not determined, or detected, by process 250. In embodiments, process 282 determines, or detects, and off-road condition but processes 290 and 282 do not determine an off-road condition, and therefore, an off-road condition is not determined, or detected, by process 250. In embodiments, process 266 determines, or detects, and off-road condition but processes 290 and 282 do not determine an off-road condition, and therefore, an off-road condition is not determined, or detected, by process 250.

In embodiments, controller 222 is configured to determine an off-road condition in process 250 when only two of the three processes 266, 282, 290 determine vehicle 2 is in an off-road condition (e.g., process 266 and process 282 determine an off-road condition, process 290 does not determine an off-road condition, and process 250 ultimately determines an off-road condition.) In embodiments, controller 222 is configured to determine an off-road condition in process 250 when only one of the three processes 266, 282, 290 determine vehicle 2 is in an off-road condition (e.g., process 266 determines an off-road condition, processes 282 and 290 do not determine an off-road condition, and process 250 ultimately determines an off-road condition.) In embodiments, when process 250 determines that the terrain is not off-road, process 250 automatically determines that vehicle 2 is traversing an on-road terrain or is an on-road condition 300 (FIG. 14A).

In embodiments, electronic controller 222 also monitors GPS sensor 221. A given location might be associated with a first terrain type based on the frequency responses of the IMU 212 on a first day, such as fresh snow, and a second terrain type based on the frequency responses of the IMU 212 on a second day, such as hard snow. In embodiments, controller 222 monitors GPS sensor 221 and one or more of ‘Determination 1’ 280, ‘Determination 2’ 288, and ‘Determination 3’ 296 to associate a terrain type (e.g., On-Road or Off-Road) with a geographical location (e.g., GPS coordinates) and may also associate a terrain type with one or more of the geographical location, timestamp, weather data, and other data. In embodiments, vehicle 2 is present at a geographical location previously associated with a given terrain. Controller 222 monitors GPS sensor 221 and historical data (e.g., from memory, a server, a network, another vehicle, or another data source) and determines from the historical data that the current location of vehicle 2 (as determined by GPS sensor 221) is associated with a particular type of terrain. In embodiments, controller 222 may monitor GPS sensor 221 and data from a map (e.g., stored in memory, or on a server, network, or other data source) to determine if vehicle 2 is travelling on a paved road, a non-paved road, an off-road trail, or another off-road location. In embodiments, the geographical terrain determination based upon GPS sensor 221 may be weighed greater within the overall terrain detection process (e.g., process 250) than other methods of terrain determination (e.g., ‘Determination 1’ 280, ‘Determination 2’ 288, ‘Determination 3’ 296), and the weight of the geographical terrain determination may be vary depending on the type of road vehicle 2 is traversing and the GPS confidence. This geographical terrain determination may be utilized in an overall terrain detection 250 as a supplemental, or additional, determination process (e.g., terrain detection process 250 includes ‘Determination 1’ 280, ‘Determination 2’ 288, ‘Determination 3’ 296, and the geographical terrain detection). In embodiments, the geographical terrain determination may be used alone, or with one or more of ‘Determination 1’ 280, ‘Determination 2’ 288, ‘Determination 3’ 296.

Referring now to FIG. 13B, in embodiments, processing sequence 250 is completed across a plurality of vehicle subsystems and/or vehicle controllers. In embodiments, a first vehicle subsystem 318 includes a first controller 320, a second vehicle subsystem 322 includes a second controller 324, and a third vehicle subsystem 326 includes a third controller 328. In embodiments, first controller 320 receives information from first vehicle subsystem 318, and optionally at least one other vehicle subsystem, and determines the ‘Determination 1’ 280 based on process 266, 266′, second controller 324 receives information from second vehicle subsystem 322, and optionally at least one other vehicle subsystem, and determines the ‘Determination 2’ 288 based on process 288, and third controller 328 receives information from third vehicle subsystem 326, and optionally at least one other vehicle subsystem, and determines the ‘Determination 3’ 296 based on process 290. That is, each determination 280, 288, 296 may be determined separately, and each controller 320, 324, 328 is configured to send its respective determination to a central controller 330 and the central controller further is configured to make the ultimate determination that vehicle 2 is traversing an off-road terrain 298. In embodiments, any of first vehicle subsystem 318, second vehicle subsystem 322, and third vehicle subsystem 326 may be the brake assembly 40, either of front suspension assembly 27, rear suspension assembly 28 (or generally overall suspension assembly 27, 28), steering assembly 26, powertrain assembly 30, or transmission system 217.

Further, each controller 320, 324, 328 may be associated with its own vehicle subsystem and may be, for example, a brake controller (e.g., HECU 60), a suspension controller 218, a steering controller, an engine controller (or prime mover controller (e.g., controller 222)), or a transmission controller 216. In embodiments, central controller 330 is the electronic controller 222. In embodiments, one of controllers 320, 324, 328 (e.g., HECU 60) may operate as the central controller 330. In embodiments, each subsystem 318, 322, 326 is then in charge of monitoring data associated with sensors of each subsystem 318, 322, 326 and subsequently analyze the data, before then transmitting only the determination to central controller 330. That is, first controller 320 may be configured to complete first determination process 266, 266′, second controller 324 may be configured to complete second determination process 282, and third controller 328 may be configured to complete third determination process 290. Decentralized computing reduces the computing burden placed on central controller 330 and also reduces the amount of information being transmitted to a single source (e.g., from various sensors).

In embodiments, terrain detection process 250 is disabled, or not actively run, when vehicle speed 214 is below a speed threshold. In embodiments, when vehicle speed 214 is less than five (5) mph, controller 222 will not run terrain detection process 250. In embodiments, the speed threshold is selectable, or alterable by an OEM, an owner, or operator of vehicle 2. In embodiments, the speed threshold may be any vehicle speed 214 (e.g., ten (10) mph, fifteen (15) mph, twenty (20) mph, or another vehicle speed).

Referring now to FIG. 14A, process 302 provides that if terrain detection process 250 determines that vehicle 2 is traversing an on-road condition 300, controller 222 is configured to alter brake assembly 40 to operate in the first brake configuration. An exemplary first brake configuration is the anti-lock brake configuration 258. Further, if terrain detection process 250 determines that vehicle 2 is traversing an off-road condition 298, controller 222 is configured to alter brake assembly 40 to operate in the second brake configuration. An exemplary second brake configuration is the adaptive anti-lock brake configuration 260.

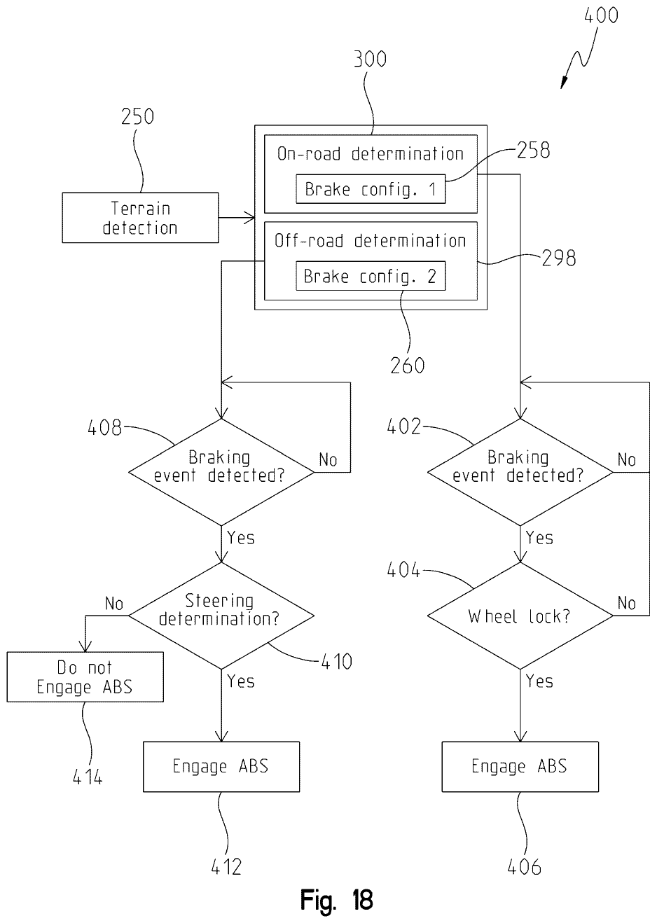

In embodiments, referring to FIG. 18, in the first brake configuration, or anti-lock brake configuration 258, brake assembly 40 is configured to operate as a standard anti-lock brake assembly, as shown by method 400. That is, for example, terrain detection process 250 determines that vehicle 2 is operating in an On-Road terrain (e.g., determination 300) and operates according to the first brake configuration 258, and if vehicle 2 detects a braking event, as referenced by block 402, controller 222 (or another controller; e.g., HECU 60) determines if one or more of ground engaging members 10, 12 are locked up, as referenced by block 404. Further, as soon as front ground engaging members 10, 12 lock up (i.e., stop rotating, as determined in block 404) but vehicle 2 continues to move forward, brake assembly 40 will start to pulse the pressure to brakes 48, 52 of ground engaging members 10, 12 (i.e., start anti-lock braking), as referenced in block 406, regardless of steering angle, vehicle speed, or other vehicle characteristics. In embodiments, in a straight-line steering condition and a braking event, brake assembly 40 will start to pulse the pressure to brakes 48, 52 of ground engaging members 10, 12 (i.e., start anti-lock braking). In embodiments, in the first brake configuration, or anti-lock brake configuration 258, controller 222 is configured to alter the use of anti-lock braking to any or all of ground engaging members 10, 12 based upon a vehicle characteristic, such as vehicle speed or steering angle.

In embodiments, still referring to FIG. 18, in the second brake configuration, or adaptive anti-lock configuration 260, brake assembly 40 is configured to operate an anti-lock braking method with brake assembly 40 in an adapted manner to operate more effectively in an off-road terrain, as shown by method 400. That is, terrain detection process 250 determines that vehicle 2 is operating an on Off-Road determination (e.g., determination 298) and operates according to the second brake configuration 260, and if vehicle 2 detects a braking event, as referenced by block 408, controller 222 (or another controller; e.g. HECU 60) makes a steering determination, as referenced by block 410. In embodiments, adaptive ABS mode 260 is configured to operate braking assembly 40 in an anti-lock braking mode only during a steering event. In embodiments, the steering determination is ‘TRUE’ only if the steering angle is a non-neutral value (e.g., non-zero) and represents a driver intent to steer the vehicle. That is, in embodiments, the steering determination is ‘TRUE’ if the steering angle (X°) is greater than zero or less than zero (e.g., X°<0 or X°>0). In embodiments, the steering determination is ‘TRUE’ if the steering angle is greater than or less than a predetermined value offset from zero (e.g., 20°; X°<−20° or X°>20). Further, the steering determination is ‘FALSE’ if the steering angle is at or approximately at a neutral steering angle (e.g., straight line steering; X≈0°). In embodiments, the steering determination is ‘FALSE’ if the steering angle is within a predetermined offset from zero (e.g., 20°; −20°<X°<20°). In embodiments, if the steering determination is ‘TRUE’, controller 222 (or another controller; e.g., HECU 60) engages the ABS functionality to allow brakes 48, 52 to pulse brake pressure to one or more of ground engaging members 10, 12, as referenced in block 412. In embodiments, if the steering determination is ‘FALSE’, controller 222 (or another controller; e.g., HECU 60) does not engage the ABS and allows the brakes 48, 52 to operate normally on one or more of ground engaging members 10, 12, and may allow ground engaging members 10, 12 to lock up, as referenced in block 414. That is, in embodiments, adaptive ABS 260, or second brake configuration 260, operates so that in a braking event as soon as front ground engaging members 10, 12 lock up (e.g., stop rotating) but vehicle 2 continues to move forward, in a straight-line steering condition, brake assembly 40 will not engage the anti-lock braking, allowing vehicle 2 to continue to move (e.g., skid) forward with the ground engaging members 10, 12 locked up. In embodiments, adaptive ABS 260 operates so that, in a braking event, when a turning event is detected, or a steering angle detected by steering sensor 236 exceeds a threshold value, adaptive ABS 260 will start to pulse the pressure to brakes 48, 52 of ground engaging members 10, 12 (i.e., start anti-lock braking). In embodiments, in adaptive ABS mode 260, anti-lock braking is only engaged when the steering angle is a non-zero value, or a non-neutral (i.e., vehicle is steered to the right or left). That is, when a user provides a user input to steering input 25, controller 222 determines that the operator of vehicle 2 desires to turn either left or right. The adaptive ABS 260 allows vehicle 2 to optimize stopping distance and steerability in an off-road, or reduced friction setting. Therefore, in the adaptive ABS mode 260, it may be desirable to, among other things, allow ground engaging members 10, 12 to be at least partially steered and powered during a turning event (i.e., in response to a user input to steering input 25) by pulsing, or reducing the brake pressure to one or more of ground engaging members 10, 12 (i.e., relieving pressure on brakes 48, 52 by activating ABS, and vehicle 2 reducing a skidding event during a turning event). In embodiments, when the lateral acceleration experienced by vehicle 2 is greater than a lateral acceleration threshold, vehicle 2 may be determined to be experiencing a sliding event. In embodiments, a sliding event is determined alone, or in combination with, a yaw rate of vehicle 2 exceeding a yaw rate threshold and/or a steering angle exceeding a steering angle threshold. In embodiments, during a sliding event, adaptive ABS 260 is configured to engage the anti-lock braking (i.e., pulsing, or reducing the pressure to brakes 48, 52) to allow ground engaging members 10, 12 to steer during the sliding event. During a sliding event, it may be advantageous to, among other things, allow ground engaging members 10, 12 to be at least partially steered and powered and not have the ground engaging members be impacted, or have their power reduced, by locking up during a turning event. Additional details regarding off-road braking systems and methods can be found in U.S. patent application Ser. No. 16/401,933, filed May 2, 2019, issued as U.S. Pat. No. 11,254,294 on Feb. 22, 2022, titled OPERATING MODES USING A BRAKING SYSTEM FOR AN ALL TERRAIN VEHICLE, attorney docket no. PLR-15-28344.03P-US, and U.S. patent application Ser. No. 16/197,497, filed Nov. 21, 2018, issued as U.S. Pat. No. 10,967,881 on Apr. 6, 2021, titled ANTI-LOCK BRAKING SYSTEM FOR UTILITY VEHICLE, attorney docket no. PLR-06-28332.02P-US, the entire disclosures of which are expressly incorporated herein by reference.

Now referring to FIG. 14B, process 304 provides that if terrain detection process 250 determines that vehicle 2 is traversing an on-road condition 300, controller 222 is configured to operate vehicle 2 with the EMS mode in an ON-condition 264. Further, if terrain detection process 250 determines that vehicle 2 is traversing an off-road condition 298, controller 222 is configured to operate vehicle 2 with the EMS mode in an OFF-condition or limited condition 262.

In embodiments, EMS is configured to operate brake assembly 40 of vehicle 2. If, in an on-road configuration, the ABS brake configuration 258 is in an ON-condition, and actively facilitating pulsing brake pressure to one of ground engaging members 10, 12, and EMS is also in an ON-condition, the EMS intervention actions have authority over the ABS actions. That is, if the EMS mode intends to alter the braking assembly 40 of vehicle 2, and ABS is currently being used on any of ground engaging members 10, 12 (i.e., actively pulsing pressure to ground engaging members 10, 12), the intervening actions of the EMS mode will be prioritized over the actions of the ABS mode.

In embodiments with a powertrain assembly 30 comprising one or more electric motors, controller 222, 252, may be configured to operate one or more of the EMS mode, the ABS mode, or the adaptive ABS mode in cooperation with, or by using, the one or more electric motors. That is, controller 222, 252 may be configured to provide a negative torque, no torque, or a reduced torque, by the one or more electric motors, to simulate a brake pulse, or brake pressure.

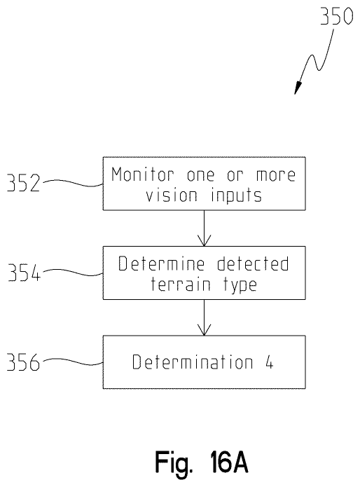

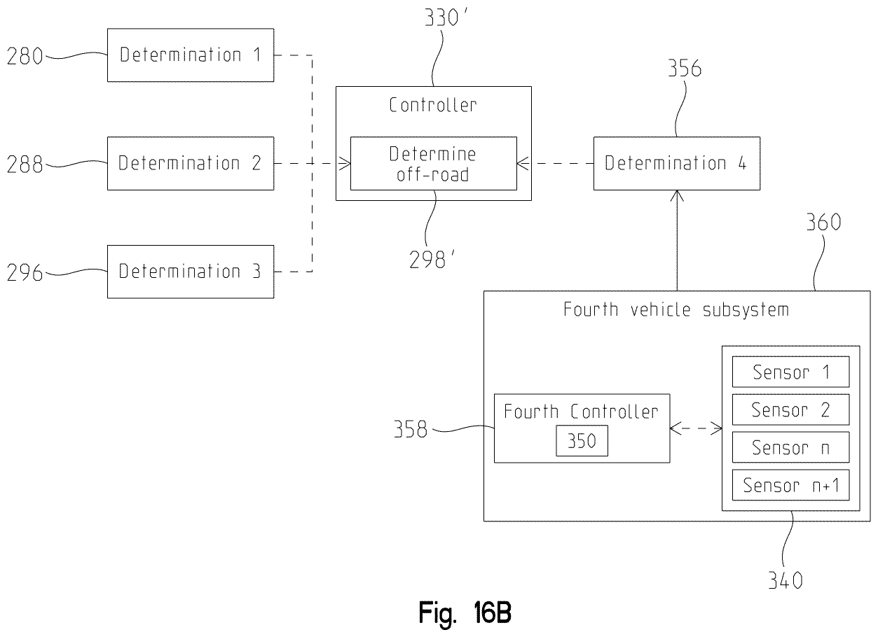

Referring now to FIGS. 16A-16B, vehicle 2 may operate with a process 350 to make an off-road determination. Process 350 includes monitoring one or more vision inputs from the one or more vision sensors 340, as represented by block 352. A controller 358 operates according to process 350 and may receive the one or more vision inputs from the one or more vision sensors 340 in step 352. Process 350 also includes determining the type of terrain (e.g., off-road, on-road, etc.), as represented by block 354, and subsequently process 350 includes confirming the terrain type in a ‘Determination 4’, as represented by block 356.

In embodiments, step 354 includes the controller 358 analyzing the one or more vision inputs from the one or more vision sensors 340 for indicators, markers, signs, lines, or other guides. In one embodiment, controller 358 analyzes the one or more vision inputs from the one or more vision sensors 340 for road lines (e.g., yellow lines, white lines, dashed lines, double lines, etc.), and if the controller 358 detects one or more road lines the controller may make a determination that the vehicle 2 is on-road. In one embodiment, the one or more vision sensors 340 have a generally panoramic view (e.g., left-to-right of the vehicle) and controller 358 may monitor the one or more vision inputs from the one or more vision sensors 340 to determine a delineation between a road and a non-road portion (e.g., a shoulder). That is, in step 354, controller may analyze the one or more vision inputs from the one or more vision sensors 340 to determine if vehicle 2 is adjacent to one or more shoulders, and in response to determining the vehicle 2 is adjacent to one or more shoulders, process 350 may output, in step 356, that vehicle is on-road. In embodiments, the vision sensors 340 may determine the delineation between the road and non-road portion (e.g., a shoulder) by determining a coloration, object detection, surface roughness of the ground, or uniformity across pixels.

Referring now to FIG. 16B, a fourth vehicle subsystem 360 includes a controller 358 coupled to the plurality of vision sensors 340. Controller 358 is configured to operate according to process 350. In embodiments, the fourth determination 356 may be used in an overall off-road determination 298′ (similar or the same as off-road determination 298). In embodiments, a controller 330′ (similar or the same as controller 330) may be configured to process and determine the overall off-road determination 298′ by utilizing one or more of the first determination 280, second determination 288, third determination 296, and fourth determination 356. In embodiments, a controller 330′ (similar or the same as controller 330) may be configured to process and determine the overall off-road determination 298′ by utilizing each of the first determination 280, second determination 288, third determination 296, and fourth determination 356. In embodiments, a controller 330′ (similar or the same as controller 330) may be configured to process and determine the overall off-road determination 298′ by utilizing one of the first determination 280, second determination 288, third determination 296, and fourth determination 356. In embodiments, a controller 330′ (similar or the same as controller 330) may be configured to process and determine the overall off-road determination 298′ by utilizing two of the first determination 280, second determination 288, third determination 296, and fourth determination 356. In embodiments, a controller 330′ (similar or the same as controller 330) may be configured to process and determine the overall off-road determination 298′ by utilizing three of the first determination 280, second determination 288, third determination 296, and fourth determination 356.

In embodiments, controller 330, 330′ may provide a confidence for each of the first determination 280, second determination 288, third determination 296, and fourth determination 356. That is, each of the determinations 280, 288, 296, 356 may be weighted differently by controller 330, 330′ based upon a predetermined confidence level in each determination 280, 288, 296, 356. In various embodiments, a first determination of the determinations 280, 288, 296, 356 may be weighted to be 40% of the overall determination, a second determination of the determinations 280, 288, 296, 356 may be weighted to be 20% of the overall determination, a third determination of the determinations 280, 288, 296, 356 may be weighted to be 30% of the overall determination, and a fourth determination of the determinations 280, 288, 296, 356 may be weighted to be 10% of the overall determination. In various embodiments, the overall determination 298, 298′ may determine an off-road terrain when the overall off-road determination 298, 298′ is greater than a predetermined threshold, such as 80%. In various embodiments, the predetermined threshold is 30%, 50%, 75%, or 100%. In embodiments, each sensor utilized in terrain detection process 250 (e.g., steering sensors 236, wheel speed sensors 80, 90, frequency sensors 232, vision sensors 340) may have a dynamic confidence level that may be adjusted by controller 330, 330′, or by the individual sensor itself.

While embodiments of the present disclosure have been described as having exemplary designs, the present invention may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this invention pertains.

1. A vehicle for traversing a terrain, the vehicle comprising:
a plurality of ground engaging members;
a frame supported by the plurality of ground engaging members;
a plurality of sensors supported by the plurality of ground engaging members and configured to monitor a plurality of vehicle characteristics;
at least one controller operably coupled to the plurality of sensors;
a brake system operably coupled to at least one of the plurality of ground engaging members;
a steering assembly operably coupled to at least one of the plurality of ground engaging members; and
at least one controller configured to determine if the terrain is a first terrain type or a second terrain type, wherein based upon at least one of the plurality of vehicle characteristics, the controller is operable to operate the braking system with a first configuration if the terrain is the first terrain type and operate the braking system with a second configuration if the terrain is the second terrain type, the second terrain type being different than the first terrain type.

2. The vehicle of claim 1, wherein the brake system is an anti-lock braking system, the first configuration of the braking system is a first ABS mode, and the second configuration of the braking system is a second ABS mode.

3. The vehicle of claim 2, wherein a first condition comprises a first input from the steering assembly and a second input from the brake system, and in the first condition, the first ABS mode is configured to operate at least one brake of the brake system associated with at least one of the plurality of ground engaging members to avoid locking-up the at least one ground engaging member and the second ABS mode is configured to operate the at least one brake of the brake system associated with the at least one of the plurality of ground engaging members to allow the at least one ground engaging member to lock-up.

4. The vehicle of claim 1, wherein the first terrain type is pavement and the second terrain type is non-pavement.

5. The vehicle of claim 4, wherein the brake system is an anti-lock braking system, the first configuration of the braking system is a first ABS mode, and the second configuration of the braking system is a second ABS mode.

6. The vehicle of claim 5, wherein a first condition comprises a first input from the steering assembly and a second input from the brake system, and in the first condition, the first ABS mode is configured to operate at least one brake of the brake system associated with at least one of the plurality of ground engaging members to avoid locking-up the at least one ground engaging member and the second ABS mode is configured to operate the at least one brake of the brake system associated with the at least one of the plurality of ground engaging members to allow the at least one ground engaging member to lock-up.

7. The vehicle of claim 6, wherein the first input is a straight-line steering angle and the second input is a brake input.

8. The vehicle of claim 1, wherein the at least one controller is configured to operate the brake system according to an evasive maneuver stabilization (EMS) mode, and the first configuration of the brake system is a first EMS mode, and the second configuration of the brake system is a second EMS mode.

9. The vehicle of claim 8, wherein in the first EMS mode the at least one controller is operable to provide a first type of intervention action to the brake system in response to at least one of the vehicle characteristics exceeding a predetermined threshold, and in the second EMS mode the at least one controller is operable to provide a second type of intervention action.

10. The vehicle of claim 1, wherein the first terrain type is pavement and the second terrain type is non-pavement.

11. The vehicle of claim 10, wherein the at least one controller is configured to operate the brake system according to an evasive maneuver stabilization (EMS) mode, and the first configuration of the brake system is a first EMS mode, and the second configuration of the brake system is a second EMS mode.

12. The vehicle of claim 11, wherein in the first EMS mode the at least one controller is operable to provide a first type of intervention action to the brake system in response to at least one of the vehicle characteristics exceeding a predetermined threshold, and in the second EMS mode the at least one controller is operable to provide a second type of intervention action.

13. The vehicle of claim 1, wherein the at least one controller is configured to monitor the at least one of plurality of vehicle characteristics according to a frequency and receive a plurality of data points associated with the at least one of the plurality of vehicle characteristics, and the at least one controller is operable to compare the plurality of data points associated with the at least one of the plurality of vehicle characteristics to at least one threshold.

14. The vehicle of claim 13, wherein the at least one controller is configured to assign a value to each of the plurality of data points based upon the relative position of each of the plurality of data points to the at least one threshold.

15. The vehicle of claim 14, wherein the at least one controller is configured to determine the terrain is the first terrain type based upon a collective value of the plurality of data points reaching a first terrain threshold.

16. The vehicle of claim 15, wherein the at least one of the plurality of vehicle characteristics is a steering characteristic.

17. The vehicle of claim 15, wherein the at least one of the plurality of vehicle characteristics is an acceleration characteristic of at least one of the plurality of ground engaging members.

18. The vehicle of claim 1, wherein the at least one controller is configured to monitor a frequency response of the at least one of the plurality of vehicle characteristic.

19. The vehicle of claim 18, wherein the at least one controller is configured to compare the frequency response of the at least one of the plurality of vehicle characteristic to a first range of values associated with the first terrain, and the at least one controller is configured to determine the terrain is the first terrain based upon the frequency response of the at least one of the plurality of vehicle characteristic being in the first range of values.

20. The vehicle of claim 1, wherein the at least one controller includes a first controller, a second controller, and a third controller, the first controller monitors a first subset of the plurality of sensors to determine a first evaluation of the terrain, the second controller monitors a second subset of the plurality of sensors to determine a second evaluation of the terrain, and the third controller receives the first evaluation of the terrain from the first controller and the second evaluation of the terrain from the second controller and classifies the terrain as one of the first terrain type and the second terrain type based thereon.
